(19) United States
(12) Patent Application Publication
(10) Pub. No.: US 2014/0163463 A1
(43) Pub. Date: Jun. 12, 2014

(54) Medicup a Medicine dispenser with soft Handles interchangeable with Strawcup

(71) Applicant: Galina A. Agbo, Avondale, PA (US)

(72) Inventor: Galina A. Agbo, Avondale, PA (US)

(21) Appl. No.: 13/711,405

(22) Filed: Dec. 11, 2012

(51) Int. Cl. A47G 19/22; B65D 25/34; A61J 7/00; B65D 25/20

(52) U.S. Cl. CPC A47G 19/2272; B65D 25/20; B65D 25/34; A61J 7/0046
USPC 604/78; 215/229; 215/396; 215/200

(57) ABSTRACT

“Medicup,” a medicine dispensing device is disclosed comprising an interior cavity defining drinking cup for containing liquid beverages, removable screw-on lid designed with adapters for closure and retaining of a valve assembly, a medicine cup located therein for holding liquid medicine and detachable drinking device defining a soft drinking spout comprising one or multiple valves with slits to dispense mixture of medicine and liquid beverage to children. Medicup, with all its embodiments is designed for administration of a single premeasured dose of medicine simultaneously with a beverage to children.

Strawcup, a drinking device is disclosed outwardly similar to the above mentioned cup.

Soft drinking devices are disclosed: two soft drinking spouts and two soft drinking straws are interchangeable between cups and lids of the Medicup and the Strawcup.

Soft removable handles assembly is disclosed: designed and formed for easy grip of the Medicup and the Strawcup.

### FIELD OF THE INVENTIONS

1) One of the main present inventions relates to Medicup medicine dispenser and drinking vessel in general, commonly known as “sippy cup” with detachable valve assembly and medicine cup for measuring and administering liquid medication to children simultaneously with liquid beverage to enhance palatability of medicine.

2) Other invention relates to Strawcup, a drinking vessel in general, commonly known as “straw cup” outwardly similar to the Medicup with interchangeable parts/embodiments with said cup.

3) Other inventions relate to essential parts/embodiments of the Medicup's and the Strawcup's detachable soft drinking devices: two soft drinking straws with plastic weighted straws, two soft drinking spouts, and four types of drinking apexes/tips comprising from one to four valves with dispensing slits.

4) Other invention relates to removable soft Handles assembly consisting of a base, an upper opening and handles designed and formed for easy grip of the Medicup and the Strawcup.

### OBJECTS OF THE PRESENT INVENTIONS

An object of the main present invention is to provide a drinking cup for daily use and also when it is needed for dispensing of an oral liquid medication to children.

An object of another invention is to provide a straw cup for daily use with interchangeable parts/embodiments with the Medicup.

Other object of the main invention is the provision of an oral liquid medicine dispenser measuring of an exact dosage and delivering of fluid or semi-fluid medication directly to a mouth of infant, toddler or child.

Other objects and advantages of the main invention are two fluids never mixed together before they enter drinking spout or collected in receptacle.

Other object and advantage of the main invention is to provide an oral liquid dispenser which is able to enhance palatability of the medication by delivering of two fluids concurrently.

Other object and advantage of the main invention is the provision of an essential part/embodiment to a medicine dispenser; a lid with two adapters specifically designed and constructed to fit and support a valve assembly for dispensing of liquid medicine and liquid beverage to children simultaneously.

Other object and advantage of the main invention is the provision of other essential part/embodiment to a medicine dispenser; a valve assembly specifically designed, constructed and formed to dispense medicine concurrently with liquid beverage and provide closure and support for a medicine cup.

Other object and advantage of the main invention is the provision of an essential part/embodiment to a medicine dispenser; a medicine cup that is designed and formed to hold and dispense liquid medicine and adapted for tight engagement with a valve of said valve assembly.

Other objects and advantages of the main invention; the amount of consumed and left over liquid beverage and medicine can be controlled independently of each other.

Other objects and advantages of the present inventions, the provision of essential parts/embodiments, the soft drinking device for the medicine dispenser which is a soft drinking spout interchangeable with the Strawcup as well as removable soft Handles assembly designed and formed for easy grip of the Medicup and the Strawcup.

Other object and advantage of another invention is the provision of essential part/embodiment; the soft drinking device for the Strawcup is a soft drinking straw mouthpiece interchangeable part/embodiment between two said cups and lids.

Other object and advantage of these inventions is a soft drinking straw connected with flexible plastic straw containing weighted distal end which is able to move in the direction of a tilted cup and helps user to collect most or all liquid from the bottom of the cup.

Other objects and advantages of these inventions, and its novel features will become obvious to those skilled in the art by examining the accompanying specification, drawings and claims.

The inventions disclosed herein are fully capable of accomplishing the objects and provide the important embodiments.

### BACKGROUND ART OF THE INVENTION

Parents and caregivers have frequent difficulties in delivery of liquid medication and some other liquid supplements to children, especially if liquid medicine has unpleasant taste or smell. A variety of medicine dispensers were proposed, capable of dispensing medicine with liquid beverage simultaneously; however, currently not many of them are available on the market or they have a rigid spout or nipple.

Medicine dispensers those disclosed in the following U.S. patents:
Chauvin, et al., D574,488 S, Aug. 5, 2008, Oral Medicine Dispenser;
Adams, U.S. Pat. No. 3,178,081, Apr. 13, 1965, Metering Liquid Dispensing Device;
Trowbkidge, U.S. Pat. No. 1,313,566, Aug. 19, 1919, Medicine-Dispenser;
Wood, U.S. Pat. No. 3,351,241, Nov. 7, 1967, Medicine Dispenser;
Martin, U.S. Pat. No. 5,129,532, Luly 14, 1992, Pediatric-Medicinal Dispensing System;
Dooley, U.S. Pat. No. 5,037,389, Aug. 6, 1991, Portable Liquid Medicine Dispenser;
Botts, U.S. Pat. No. 5,244,122, Sep. 14, 1993, Medicine Dispensing Baby Bottle;
Waring, U.S. Pat. No. 4,966,312, Oct. 30, 1990, Disposable Oral Liquid Measure Dispenser;
Lenkersdorf, U.S. Pat. No. 6,981,962 B1, Jan. 3, 2006, Liquid Dispensing Device;
Hakim, 2012/0091143 A1, Apr. 19, 2012, No-spill Drinking Products;
Elmore, U.S. Pat. No. 3,323,689, Jun. 6, 1967, Dispensing Bottle;
Burchett, et al., U.S. Pat. No. 5,824,012, Oct. 20, 1998, Nursing Bottle with Medication Dispenser;
Franchi, Des. 380,828, Jul. 8, 1997, Infant Medicine Dispenser;
Noble, U.S. Pat. No. 5,176,705, Jan. 5, 1993, Medication Dispensing Pacifier;
Roth, Schwinger, U.S. Pat. No. 5,029,701, Jul. 9, 1991, Medicine Dispenser insert for nursing bottles;
Burchett et al., 6,200,295, Mar. 13, 2001, Nursing Bottle with Medication Dispenser;
Botts, U.S. Pat. No. 6,270,519, Aug. 7, 2001, Nipple for Use with Liquid and Medicine Dispensing Bottle;
Burchett, U.S. Pat. No. 5,383,906, Jan. 24, 1995, Nursing Bottle with Medication Dispenser;
Jones, U.S. Pat. No. 5,431,680, Jul. 11, 1995, Device for Orally Administering Liquid;
Burchett et al., U.S. Pat. No. 5,487,750, Jan. 30, 1996, Nursing Bottle with Medication Dispenser;
Botts, U.S. Pat. No. 5,244,122, Sep. 13, 1993, Medicine dispensing baby bottle;
Kennedy et al. U.S. Pat. No. 3,302,644, Feb. 7, 1967, Oral Medicine Administering Device for Children;
Marsden, U.S. Pat. No. 7,198,167 B2, Apr. 3, 2007, Sipper cup with Medicine Dispenser;
Roth, U.S. Pat. No. 5,029,701, Jul. 9, 1991, Medicine Dispenser Insert for Nursing Bottles.

### BACKGROUND OF THE RELATED ART INVENTION

Dentists and Speech Pathologists recommend that young children start using a straw for drinking liquid at an early age; which helps promote healthy teeth development, prevent tooth decay and prevent the development of lips and speech articulation problems. Therefore, it is important for infants, toddlers and young children to use not only sippy cups but learn to use straw cups.

The present invention the Strawcup is designed to accompany the Medicup for exchanging of drinking devises between cups for daily usage of both cups, however, the said Strawcup has its own advantages;
it is a spill and leak-free cup,
it is easy to clean,
it has detachable and replaceable soft drinking straw, and flexible plastic straw containing weighted distal end which can move in the direction of a tilted cup and help a child collect most or all liquid from the bottom of the cup.
   Many prior art devices of straw cups were proposed previously but they cannot be used with Medicup for exchanging of soft drinking devices due to differences in designs and sizes those disclosed in the following U.S. patents: Reeves, U.S. Pat. No. 4,573,631, Mar. 4, 1986, Disposable Straw, Lid and Cup Combination;
Spence, U.S. Pat. No. 5,361,934, Nov. 8, 1994, Pop-up Straw for Juvenile Drinking Cup;
Conaway, U.S. Pat. No. 7,124,907 B2, Oct. 24, 2006, Sippy Straw Cup;
Chomik, Des. 408,220, Apr. 20, 1999, Cup with Straw-Sealing Cap;
Valderrama, US 2011/0284538 A1, Nov. 24, 2011, Infant Trainer Cup with Straw Lid;
Duncan, U.S. Pat. No. 4,043,478, Aug. 23, 1977, Beverage Container with Integral Straw.

The Medicup is capable of delivering fluid or semi-fluid medications and liquid beverages to infants, toddlers or children simultaneously by enhancing palatability of medicine, allowing children to take medicine willingly along with favorite drink, eliminating spilling of medicine and restraining of children during medicine administration.

During the natural drinking process the medicine is taken through a soft drinking spout with a familiar fluid which disguises the taste of the medicine. The design of the present invention allows concurrent dispensing of liquid medication along with liquid beverage and control of remaining medicine and beverage.

The Strawcup is outwardly similar to the Medicup but with different drinking device; a detachable soft drinking straw with weighted plastic straw attached to its distal end or soft detachable spout replaced from Medicup. Also, the Strawcup's lid has only one air vent and does not contain adapters inside.

The soft drinking spout and soft drinking straw with attached weighted plastic straw are integral parts/embodiments of the Medicup and the Strawcup.

The removable soft Handles assembly is another embodiment of said cups, designed and formed for easy grip of the Medicup and the Strawcup.

The primary purpose of the Strawcup in this invention is cost effective to a customer who can use two cups on a daily basis with exchanged soft drinking straw and soft drinking spout from the Medicup. Since Medicup's lid contains additional cylindrical structure/adapters inside; therefore, on a daily basis it is better to use it with the soft drinking straw replaced from the Strawcup and the soft drinking spout exchanged to the Strawcup for easy cleaning. Another advantage of using these cups daily is for a child to become accustomed to it, which eliminates possibility of otherwise unfamiliar cup rejection during medicine administration.

Most prior art inventions have nipples or pacifiers and primarily intended for use by infants or the sippy cup for children with rigid drinking spout, in contrast, the present invention is designed with detachable and replaceable soft drinking spout. This invention is designed in effort to alleviate difficulties in administration of medicine to children of different age groups. Based on all said facts my inventions were designed.

### SUMMARY OF THE INVENTIONS

Medicup represents a medicine dispensing device for dispensing measured amount of liquid medicine to children. The Medicup comprises of five indispensable separate embodiments, four of which are made of flexible thermoplastic or other suitable material preferably by blow-molding and one made of silicone or other soft, flexible suitable material.

According to the present invention, five Medicup's embodiments are; a cylindrical body forming interior cavity of a drinking cup for holding liquid beverage, which can be filled-up through the cup's upper opening and closed, a detachable graduated medicine cup containing internal cavity for holding liquid medicine accessible through drinking cup's upper opening, a detachable valve assembly secured to lid's internal structure/adapters, a detachable soft drinking spout, a removable screw-threaded lid for covering and tightly sealing a mouth/opening of said drinking cup. Another embodiment is a soft removable Handles assembly designed and formed for easy grip of said Medicup is presented in the current invention. The main cavity of drinking cup houses the medicine cup with calibration marks formed along its edge. The screw-threaded lid fits over the rim of a threaded neck of the drinking cup and detachably secured to it.

The valve assembly consists of three different shape valves and small handle. Two of the said valves form adapters constructed and sized to fit/engage with the lid's special adapters to secure and retain the valve assembly on the lid. One of the said valves contains a leak-free air vent to supply air into the medicine cup and also forms an adapter. The second valve contains a duct for medicine dispensing and a conduit for delivery of liquid beverage to a soft drinking spout and also forms an adapter. The third valve forms a closure for the medicine cup and comprises of leak-free air vent and opening for liquid medicine. The medicine dispensing duct constructed of oval cylindrical structure with upper opening and conduit for liquid beverage are constructed of semi-circular cylindrical structure with upper opening; both are extended towards the mouthpiece. The duct and the conduit on its upper sides are covered with silicone diaphragms permanently attached by additional plastic tubes. The silicone diaphragms have “x” or “x-wavy” shaped dispensing slits/openings with approximately equal sizes 1 to 1 for adequately high flow rate of liquids or the size of the medicine duct's slits are slightly smaller than the size of the conduit's slits. The medicine dispensing duct and the conduit for liquid beverage are surrounded by cylindrical semi-circle sidewalls with hollow space inside to form a receptacle, but the outer walls form an adapter for engagement with lid's adapters to support and retain the valve assembly on said lid for medicine dispensing. Both said duct and conduit are located on the proximal, upper right side of the valve assembly and on its left side are located an air vent inside of another cylindrical adapter. The said adapter constructed and sized for tight engagement with lid's adapter to provide additional support for retaining of said valve assembly on said lid.

The said valve assembly comprises a circular shape valve on its left distal side and constructed with circular treads for air-tight engagement with screw-threaded neck of the medicine cup. The valve on its ceiling/upper side contains a leak-free air vent and medicine dispensing opening. The said valve configured for closure and support of said medicine cup which helps keep it in fixed position during medicine dispensing. The medicine cup is detachably and securely connected to a said screw type closure formed on the valve assembly.

On its right distal side the valve assembly comprising a small handle and semi-circular opening is constructed of larger size for easy cleaning than its upper counterpart and formed for delivery of liquid beverage from the interior cavity of drinking cup to a drinking spout. The handle is sized to fit at least one finger for handling of said valve assembly for inserting into or removing it from said lid's adapters.

Two leak-free air vents are located on the lid's surface and one leak-free air vent is on the upper left side of said valve assembly. All air valves consist of “x or x-wavy” shape slits through silicone diaphragm/membrane and hard ring made of decorative shape permanently attached to the lid's or valve assembly's surface. The slits are normally closed but they open to allow air circulation inside of the cup when child drinks from the spout and applies negative pressure inside of the interior cavity. The slits close when child stops drinking liquid from the spout and negative pressure is no longer applied inside of the cup, therefore, preventing leaking of medicine and liquid beverage. The Straw cup's lid has no adapters inside compared to the Medicup's lid and has only one leak-free similar air vent covered by silicone membrane with similar type of slits.

The air vent includes a hard ring made of ornamental form defining a hard decorative ring placed inside of extended inward projection on top of said silicone membrane to cover the air opening. The said projection is preferably made during molding of the lid. The air vent formed on the valve assembly in similar way as the air vent of said lid with the exception of its circular shape of the hard ring defining a hard circular ring. The silicone diaphragm/membrane with “x” or “x-wavy” shaped slits in its center is permanently fixed on the lid's or the valve assembly's surface by the hard decorative or circular ring.

The lids are formed with peripheral grooves and sized to receive upper rims of drinking cups of the Medicup and the Strawcup. The lids form air-tight seals around its rims with treaded necks of said cups. On its upper ends the said lids contain mouths/openings for removable soft drinking spout or soft drinking straw. Each said opening forms two flat surfaces on its upper and lower rims where its upper rim forms concave shape disk, but on its said lower rim forms an additional annular ring. Each said opening is constructed and sized to fit and securely engaged with soft drinking spout or soft drinking straw preventing leaking of liquid.

The soft removable leak-free drinking spout is sized to fit within a human mouth with multiple slits/openings which provides adequately high flow liquid rate during suction process and communication between drinking spout and the interior cavity of the drinking cup. The opening formed in the depression positioned inside of the spout's apex sidewalls and defined by valve/s with “x” or “x-wavy” shaped slits through the silicone surface. Each dispensing pair of slits is surrounded by said oval shape valve with rigid sidewalls attached to a drinking spout's internal upper sidewalls and between valves providing support and prevent inversion of it in response to gravity of inverted cup and to vacuum applied at spout's apex allowing child to drink liquid out of the spout. According to the present invention two types of spouts and four types of tips/apexes are disclosed. Each tip/apex can comprise from one through four of different shape valve/s with dispensing slits.

The soft removable leak-free drinking straw is also sized to fit within a human mouth and defines a valve with “x” or “x-wavy” slits providing adequately high flow liquid rate during sipping process. The soft drinking straw's extended soft distal end connects to a second piece of flexible, plastic straw and provides communication between drinking straw mouthpiece and the interior cavity of a drinking cup. A flexible, plastic straw made of clear, flexible plastic or other suitable safe material. Distal end of said plastic straw comprises a funnel-shaped interior walls and weighted curved outer sidewalls which preferably formed during straw molding. The straw's extended soft distal end under attached weighted straw can move in the direction of a tilted cup. The said soft straw's apex consists of a depression formed and positioned within its inner sidewalls containing a valve. The said valve consisting of rigid sidewalls with dispensing “x” or “x-wavy” shaped slits through a silicone diaphragm in its center is attached to the straw's internal sidewalls and provides dispensing of liquid in response to a vacuum applied at the external soft straw's tip/apex allowing child to sip liquid out of the cup.

The following are easy steps describing how to assemble the currently invented medicine dispenser for dispensing of medication to infant, toddler or child.

1) The soft drinking spout inserted through the lid's upper mouth/opening and tightly secured to the lid's opening.
2) The valve assembly securely connected by snap-fit engagement with specifically constructed and shaped internal lid's cylindrical structure/adapters for retaining of it on the lid during medicine dispensing.
3) The Medicup's drinking cup prefilled with liquid beverage recommended for children.
4) The medicine cup prefilled with liquid medicine and screwed into the valve assembly.
5) The assembled said lid placed on top of said prefilled drinking cup and securely closed.
6) Now fully assembled Medicup the medicine dispenser inserted into a soft Handles assembly and the medicine dispenser is ready for use by infant, toddler or child or it also can be used without soft Handles.

The amount of consumed liquid and medicine can be controlled independently of each other since two fluids never mixed together before they enter a mouthpiece/drinking spout.

The main differences of these inventions compared to many others prior art inventions are listed below.

1. This invention eliminates restraining of children during medicine administration because the Medicup is able to dispense kid's familiar/favorite drink for example milk or juice or other pleasant-tasting liquid concurrently with medicine. This is the advantage of the present invention because it minimizes a chance for children to protest and they consume liquids willingly which makes medicine administration easier to children of different age groups.
2. The Medicup is a leak-free cup and it does not require using the valve assembly other than for its intended purpose such as medicine, vitamins or other supplements dispensing.
3. Additionally, the design of this invention allows disassemble of the Medicup if necessary to reduce the amount of consumed liquid by removing drinking cup from the lid, emptying it or replacing with drinking cup from Strawcup and screwing the lid back onto the cup for easy handling of the Medicup and allowing child to finish drinking the left over mixture in the receptacle and/or medicine cup.
4. The Straw cup and the Medicup in most part have similar designs, therefore, the soft spout and the soft drinking straw with detachable straw can be interchanged between cups when Medicup is not used for medicine dispensing, therefore, it can be used as a Straw cup for easy cleaning.
5. A soft drinking straw with attached plastic straw can freely move under the weighted distal end in the tilted cup's direction allowing the child to collect most or all the liquid from the bottom of said cup.
6. The removable soft Handles assembly is designed and formed for easy grip of the Medicup and the Strawcup.

Many prior patents were focused on medicine dispenser inventions for children, however, not many can be found on a market but those available have their own advantages and limitations. The general objective of the present invention is to provide a novel oral medicine dispenser containing a drinking cup and medicine cup which communicate with soft drinking spout through a valve assembly allowing concurrent dispensing of liquid medicine along with liquid beverage to children of different age groups without struggle. Additionally, the possibility of using the same cup on a daily basis as a straw cup (for easier cleaning) with exchanged soft drinking straw when it is not used for medicine dispensing and to have an additional cup for use as a sippy cup.

### BRIEF DESCRIPTION OF THE INVENTIONS AND DRAWINGS

One of the preferred embodiments provided for the present invention is the valve assembly for medicine dispensing which is designed to have two contoured upper cylindrical tubes/adapters near the openings for adaption and sealing engagement with specifically constructed lid's adapters. Two lid's adapters are dimensioned and precisely sized thereby to provide sealing and supporting engagement between the valve assembly and the lid. The precise amount/dosage of medicine, vitamins or other liquid supplements prefilled in the graduated medicine cup through its open upper end and securely screwed into the valve assembly's specifically constructed circular valve. The said valve forms a closure with usual annular closure ring by threaded engagement between said closure ring and the medicine cup's treaded neck. Assembled lid along with intact soft drinking spout screwed onto the prefilled Medicup's upper opening with usual annular closure ring providing threaded engagement between lid's screw-on threads and screw-threaded neck of the drinking cup. The fully assembled Medicup is inverted as child drinks liquid from the spout creating a negative pressure inside of the drinking cup and the medicine cup forcing the silicone slits to open on the valve assembly and on the air vents allowing medicine and liquid beverage (for example milk or juice) to flow into the mouthpiece/drinking spout dispensing the mixture to the mouth of a child. After a child discontinues drinking from the spout this eliminates the negative pressure inside of the cups and forces the silicone slits to come back to a previous position and close the openings.

Other embodiments provided to the present inventions are drinking devices; two soft drinking spouts and two soft drinking straws connected with similar curved plastic straws containing weighted distal ends; also, removable soft Handles assembly designed and formed for easy grip of the Medicup and the Strawcup.

To comprehend better the current inventions, the objects and advantages thereof; it will be readily evident from the following detailed description of explanatory embodiments along with many pages of the accompanying drawings, which are made for illustration purposes only, where there are preferred embodiments presented for the current inventions.

The detailed description and claims of my inventions refer to the accompanying figures and are listed below:

FIG. 1 is a respective view of the Medicup showing side view of the medicine dispenser according to the present invention, preferred embodiment of claim 1.

FIG. 1a is a substitute specification to FIG. 1 without markings contains no new matter.

FIG. 2 is an enlarged view of the annular closure ring on rotatable, screw-on lid shown in FIG. 1.

FIG. 2a is a substitute specification to FIG. 2 without markings contains no new matter.

FIG. 3 is a front view illustrating the cup shown in FIG. 1, preferred embodiment of claims 1, 2.

FIG. 3a is a substitute specification to FIG. 3 without markings contains no new matter.

FIG. 4 is a sectional view of the drinking cup shown in FIG. 1, preferred embodiment of claims 1 and 2.

FIG. 4a is a substitute specification to FIG. 4 without markings contains no new matter.

FIG. 5 is a sectional view of the lid with intact soft drinking spout, preferred embodiment of claims 1, 3, 4, 11 and 16.

FIG. 5a is a substitute specification to FIG. 5 without markings contains no new matter.

FIG. 6 is a sectional view of the cup and the lid with two air-vents, two cylindrical adapters and annular lid's mouth/opening suitable for receiving of soft drinking spout or soft drinking straw, preferred embodiment of claims 1, 2, 3, 7, 10, 11, 13 and 16.

FIG. 6a is a substitute specification to FIG. 6 without markings contains no new matter.

FIG. 7 a portion of the lid's mouth/opening designed for tight engagement with soft drinking spout or soft drinking straw broken away showing in a larger view shown in FIG. 6, preferred embodiment of claims 1, 11, 13 and 16.

FIG. 7a is a substitute specification to FIG. 7 without markings contains no new matter.

FIG. 8 is shown side detail view of the soft drinking spout, preferred embodiment of claims 10, 11 and 12.

FIG. 8a is a substitute specification to FIG. 8 without markings contains no new matter.

FIG. 8a is shown three dimensional side view shown in FIG. 8 of the soft drinking spout, preferred embodiment of claims 10, 11 and 12.

FIG. 8b is a substitute specification to FIG. 8a without markings contains no new matter.

FIG. 9 is a sectional detail side view of the second soft drinking spout, preferred embodiment of claims 10, 11 and 12.

FIG. 9a is a substitute specification to FIG. 9 without markings contains no new matter.

FIG. 10 is a detail view of the soft spout's tip/apex of FIGS. 8, 8a and 9 comprising three valves with dispensing slits/openings, preferred embodiment of claims 11 and 12.

FIG. 10a is a substitute specification to FIG. 10 without markings contains no new matter.

FIG. 11 is a detail view of the soft spout's tip/apex of FIGS. 8, 8a and 9 comprising two valves with dispensing slits/openings, preferred embodiment of claims 11 and 12.

FIG. 11a is a substitute specification to FIG. 11 without markings contains no new matter.

FIG. 12 is shown frontal detail view of the spout of FIGS. 8 and 8a, preferred embodiment of claims 11 and 12.

FIG. 12a is a substitute specification to FIG. 12 without markings contains no new matter.

FIG. 13 is a detail sectional view of the assembled medicine dispenser without soft drinking spout, preferred embodiment of claims 1, 2, 3, 4, 5, 6, 7, 9 and 10.

FIG. 13a is a substitute specification to FIG. 13 without markings contains no new matter.

FIG. 14 is a side view of the valve assembly, the essential component for medicine dispensing; it is preferred embodiment of the Medicup and claims 1 and 4.

FIG. 14a is a substitute specification to FIG. 14 without markings contains no new matter.

FIG. 15 is a front view of the valve assembly, the essential component for medicine dispensing; it is preferred embodiment of the Medicup and claims 1 and 4.

FIG. 15a is a substitute specification to FIG. 15 without markings contains no new matter.

FIG. 16 is an enlarged detail sectional view of the valve assembly with the medicine cup, preferred embodiment of claims 1, 4, 5, 7 and 9.

FIG. 16a is a substitute specification to FIG. 16 without markings contains no new matter.

FIG. 17, FIG. 18, FIG. 19, FIG. 24, FIG. 27 and FIG. 28 shown indispensable components included in the valve assembly for medicine dispensing and preferred embodiments of the Medicup and claims 1 and 4.

FIG. 17 is perspective view of the medicine cup's annular closure ring located on the valve assembly of FIGS. 13 and 16, preferred embodiment of claims 1 and 4.

FIG. 17a is a substitute specification to FIG. 17 without markings contains no new matter.

FIG. 18 is shown sectional view of the cylindrical valve/adapter with the air vent located on the left upper end of the valve assembly, preferred embodiment of claims 1 and 4.

FIG. 18a is a substitute specification to FIG. 18 without markings contains no new matter.

FIG. 19 is a top plan view illustrating the air vent located on the valve assembly, preferred embodiment of claims 4 and 7.

FIG. 19a is a substitute specification to FIG. 19 without markings contains no new matter.

FIG. 20 is a front view of the medicine cup, preferred embodiment of claim 5.

FIG. 20a is a substitute specification to FIG. 20 without markings contains no new matter.

FIG. 21 is a bottom plan view of the Medicup's lid, preferred embodiment of claims 1, 3, 4, 7 10, 13 and 15.

FIG. 21a is a substitute specification to FIG. 21 without markings contains no new matter.

FIG. 22 is a top plan view of the Medicup's lid with two air vents, preferred embodiment of claims 1, 3, 7, 10, 11, 13, 14, 15 and 18.

FIG. 22a is a substitute specification to FIG. 22 without markings contains no new matter.

FIG. 23 is a perspective view of the components included in the lid; shown two decorative hard rings for the air vents and the decorative hard rings with silicone members, preferred embodiment of claims 1, 7 and 17.

FIG. 23a is a substitute specification to FIG. 23 without markings contains no new matter.

FIG. 24 is an exploded detail view of the air vent, preferred embodiment of claims 1, 3, 7, 13 and 17.

FIG. 24a is a substitute specification to FIG. 24 without markings contains no new matter.

FIG. 25 is a bottom detail view of the valve assembly, preferred embodiment of claims 1 and 4.

FIG. 25a is a substitute specification to FIG. 25 without markings contains no new matter.

FIG. 26 is a top detail view of the valve assembly, preferred embodiment of claims 1, 4.

FIG. 26a is a substitute specification to FIG. 26 without markings contains no new matter.

FIG. 27 is a detail view of the components included in the valve assembly as shown in FIG. 26; a view of the soft cylindrical tubes made of silicone, preferred embodiment of claims 1 and 4.

FIG. 27a is a substitute specification to FIG. 27 without markings contains no new matter.

FIG. 28 is a detail view of the components included in the valve assembly as shown in FIG. 26; a view of the hard cylindrical tubes, preferred embodiment of claims 1 and 4.

FIG. 28a is a substitute specification to FIG. 28 without markings contains no new matter.

FIG. 29 is a detail view of one of two sides of the graduated medicine cup, preferred embodiment of claims 1 and 6.

FIG. 29a is a substitute specification to FIG. 29 without markings contains no new matter.

FIG. 30 is a detail view of another side of the graduated medicine cup, preferred embodiment of claims 1 and 6.

FIG. 30a is a substitute specification to FIG. 30 without markings contains no new matter.

FIG. 31 is a detail view of the ornamental attachment for the bottom of drinking cup, preferred embodiment of claim 19.

FIG. 31a is a substitute specification to FIG. 30 without markings contains no new matter.

FIG. 32 is a detail view of the second ornamental attachment for the bottom of drinking cup, preferred embodiment of claim 19.

FIG. 32a is a substitute specification to FIG. 32 without markings contains no new matter.

FIG. 33 is a detail view illustrating the third ornamental attachment for the bottom of drinking cup, preferred embodiment of claim 19.

FIG. 33a is a substitute specification to FIG. 33 without markings contains no new matter.

FIG. 33a is an enlarged sectional view illustrating the portion of ornamental attachment shown in FIG. 33 designed for decoration of the bottom of drinking cup, preferred embodiment of claim 19.

FIG. 33b is a substitute specification to FIG. 33a without markings contains no new matter.

FIG. 34 is a left side view of fully assembled and decorated cup with the lid decorated with stars, preferred embodiment of claims 1, 18 and 19.

FIG. 34a is a substitute specification to FIG. 34 without markings contains no new matter.

FIG. 35 is a perspective front view of fully assembled and decorated cup with the lid decorated with stars, preferred embodiment of claims 1, 18 and 19.

FIG. 35a is a substitute specification to FIG. 35 without markings contains no new matter.

FIG. 36 is a perspective right side view of fully assembled and decorated cup with the lid decorated with ovals and covered by the lid's cover, also decorated with soft leaves in the gripping area and ornamental attachment on the bottom of the cup, preferred embodiment of claims 1, 18, 19 and 20.

FIG. 36a is a substitute specification to FIG. 36 without markings contains no new matter.

FIG. 37 is a perspective front view of fully assembled and decorated cup similar to a view shown in FIG. 35 and FIG. 36 but with different ornaments, preferred embodiment of claims 1, 18 and 19.

FIG. 37a is a substitute specification to FIG. 37 without markings contains no new matter.

FIG. 38 is an illustration of the ornamental soft leaf designed for decorative and easy gripping purpose, preferred embodiment of claim 18.

FIG. 38a is a substitute specification to FIG. 38 without markings contains no new matter.

FIG. 39 is shown the bottom side of the cup with ornamental attachment, preferred embodiment of claim 19.

FIG. 39a is a substitute specification to FIG. 39 without markings contains no new matter.

FIG. 40 is a detail view of the soft drinking straw with portion of a flexible plastic straw, preferred embodiment of claims 13 and 16.

FIG. 40a is a substitute specification to FIG. 40 without markings contains no new matter.

FIG. 41 is a view illustrating the bottom of the soft drinking straw, preferred embodiment of claims 13 and 16.

FIG. 41a is a substitute specification to FIG. 41 without markings contains no new matter.

FIG. 42 is a transverse section of the soft drinking straw with portion broken away, showing in a larger view, preferred embodiment of claims 13 and 16.

FIG. 42a is a substitute specification to FIG. 42 without markings contains no new matter.

FIG. 43 is a top plan view of the drinking tip of the soft drinking straw shown in FIG. 40 and FIG. 48, preferred embodiment of claims 13 and 16.

FIG. 43a is a substitute specification to FIG. 43 without markings contains no new matter.

FIG. 44 is a sectional view of intact straw cup with soft drinking straw and flexible plastic straw in accordance with another invention of the present disclosure, preferred embodiment of claims 13, 14, 15, 16 and 17.

FIG. 44a is a substitute specification to FIG. 44 without markings contains no new matter.

FIG. 45 is an enlarged sectional view of the straw's weighted distal end shown in FIG. 44, preferred embodiment of claims 13 and 16.

FIG. 45a is a substitute specification to FIG. 45 without markings contains no new matter.

FIG. 46 is a perspective right side view of the decorated straw cup with similar ornaments shown in FIG. 34, FIG. 35 and FIG. 36, FIG. 37 and with the lid cover, preferred embodiment of claims 13, 18, 19 and 20.

FIG. 46a is a substitute specification to FIG. 46 without markings contains no new matter.

FIG. 47 is a front view of the decorated Straw cup with third ornamental attachment on the drinking cup and the lid decorated with ovals, preferred embodiment of claims 13, 18 and 19.

FIG. 47a is a substitute specification to FIG. 47 without markings contains no new matter.

FIG. 48 is a detail view of the second soft drinking straw, preferred embodiment of claims 13 and 16.

FIG. 48a is a substitute specification to FIG. 48 without markings contains no new matter.

FIG. 49 is a detail side view of the lid cover, preferred embodiment of claims 1 and 13.

FIG. 49a is a substitute specification to FIG. 49 without markings contains no new matter.

FIG. 50 is a detail view of the soft spout's tip/apex of FIGS. 8, 8a and 9 comprising one valve with dispensing slits/opening, preferred embodiment of claims 11 and 12.

FIG. 50a is a substitute specification to FIG. 50 without markings contains no new matter.

FIG. 51 is a detail view of the soft spout's tip/apex of FIGS. 8, 8a and 9 comprising four valves with dispensing slits/openings, preferred embodiment of claims 11 and 12.

FIG. 51a is a substitute specification to FIG. 51 without markings contains no new matter.

FIG. 52 is a detail view of the soft removable Handles assembly designed and formed for easy grip of the Medicup and the Strawcup, preferred embodiment of claims 1, 8 and 13.

FIG. 52a is a substitute specification to FIG. 52 without markings contains no new matter.

FIG. 53 is a detail view of assembled Medicup with soft removable Handles assembly, preferred embodiment of claims 1, 8 and 13.

FIG. 53a is a substitute specification to FIG. 53 without markings contains no new matter.

### DETAILED DESCRIPTION OF PREFERRED EMBODIMENTS OF THE DISCLOSURES

The Medicup is spill and leak-free medicine dispenser outwardly similar to a conventional sippy cup assembly which includes a drinking cup for holding liquid such as milk, juice or other liquid beverage, a lid to securely close the cup, a valve assembly, a medicine cup and soft drinking spout for dispensing medicine to children. The Medicup provides an effective means for accomplishing its intended function dispensing of a liquid medication into the mouth of an infant, toddler or child.

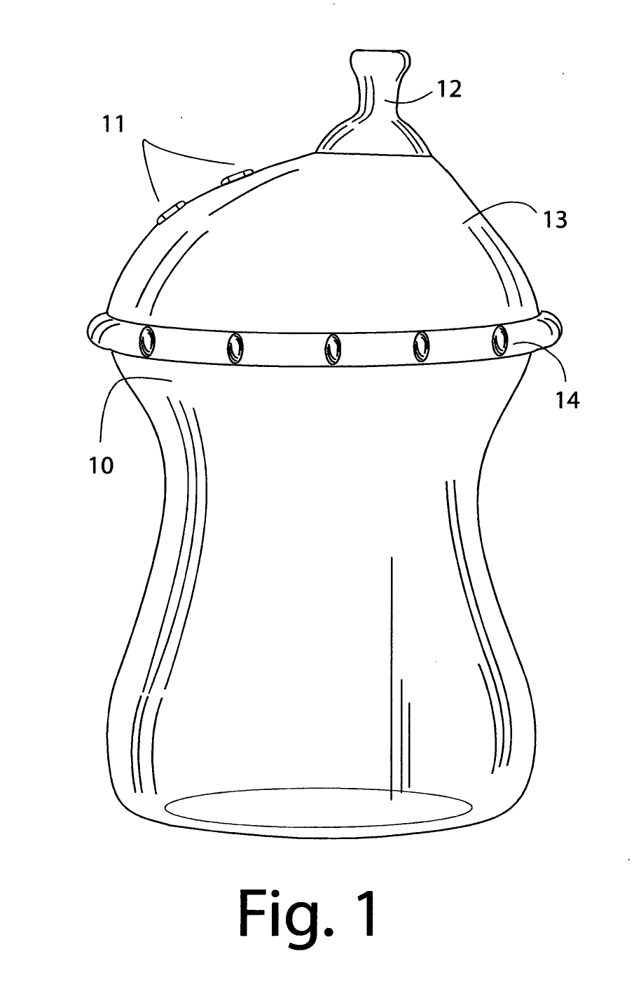

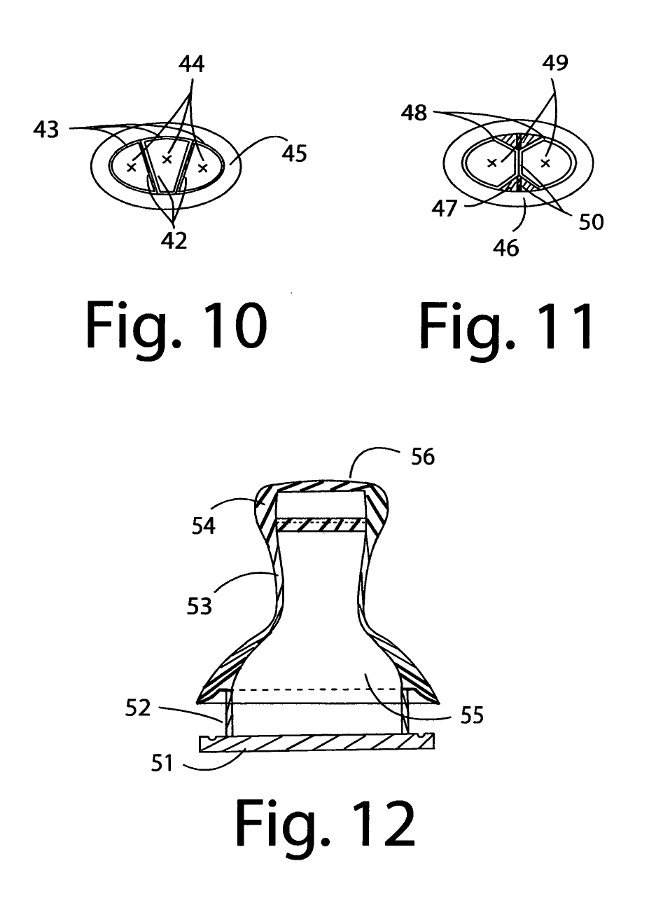

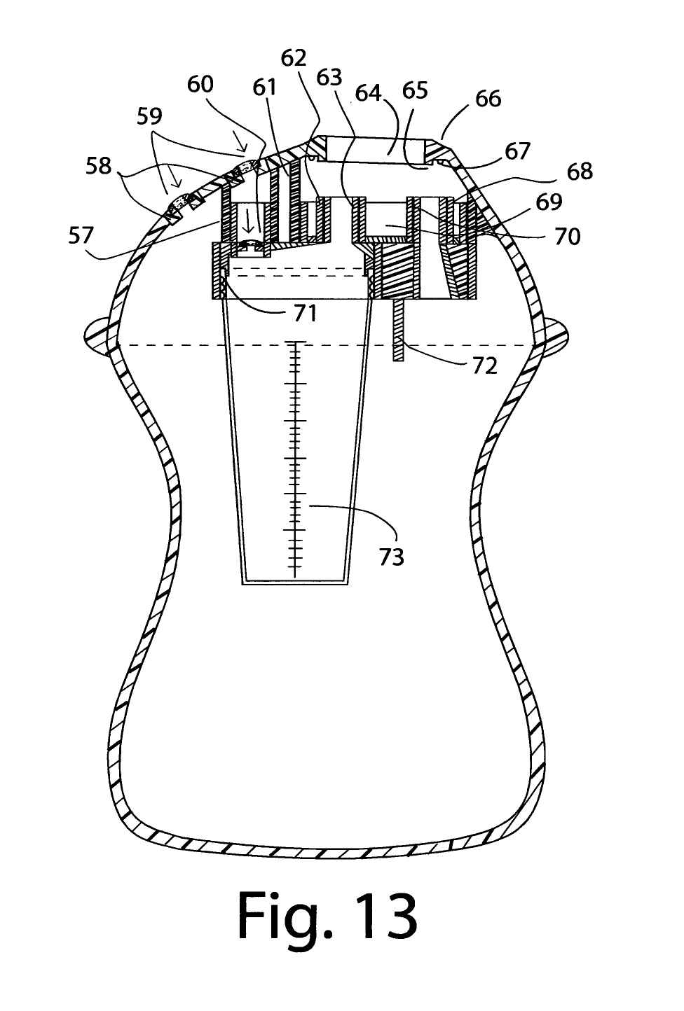

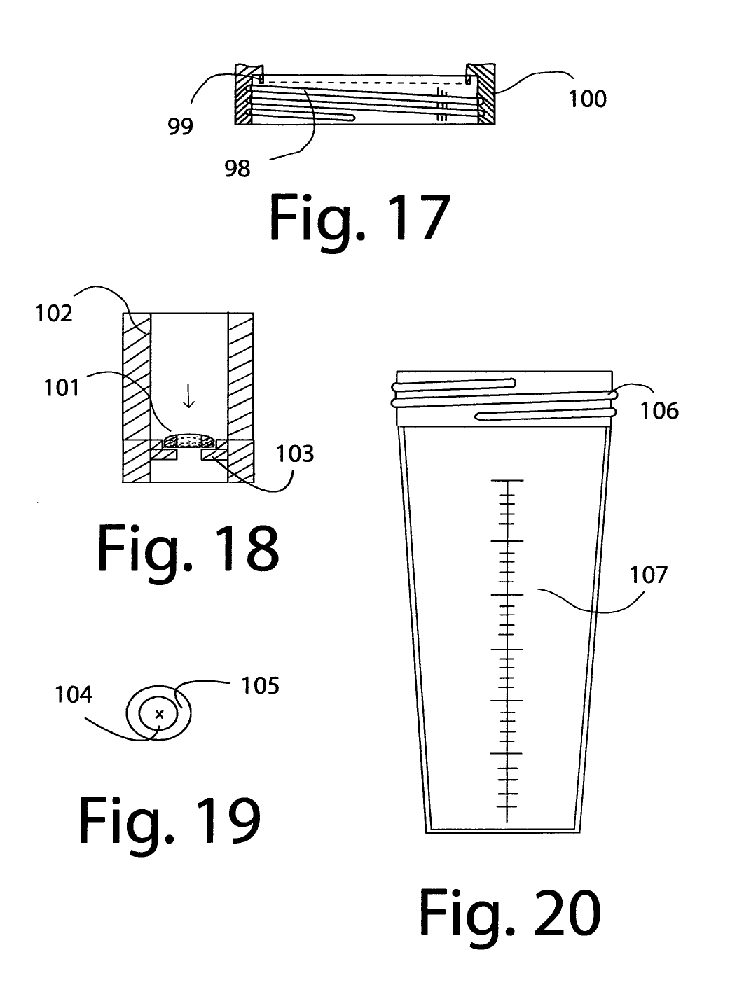

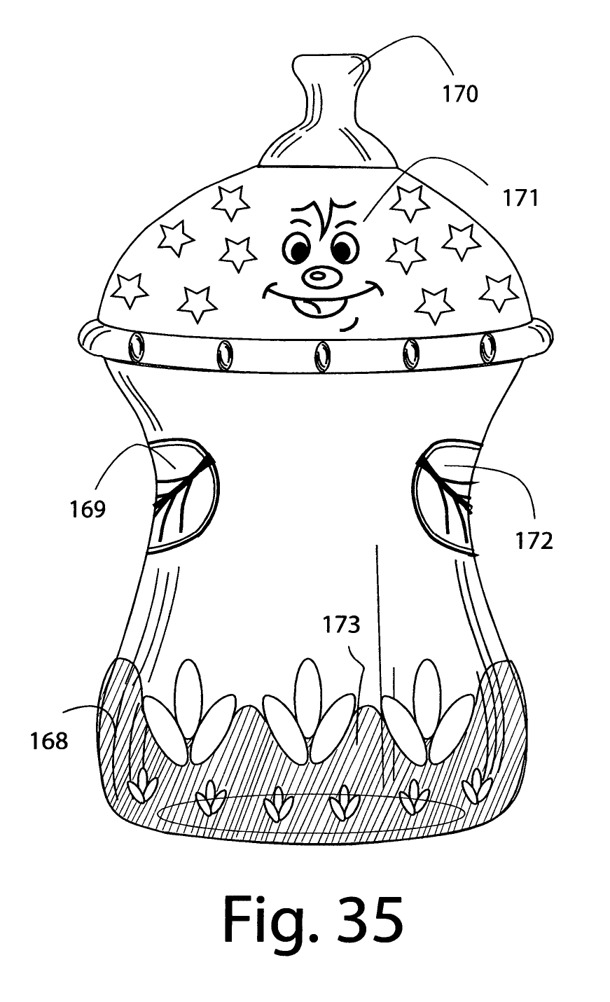

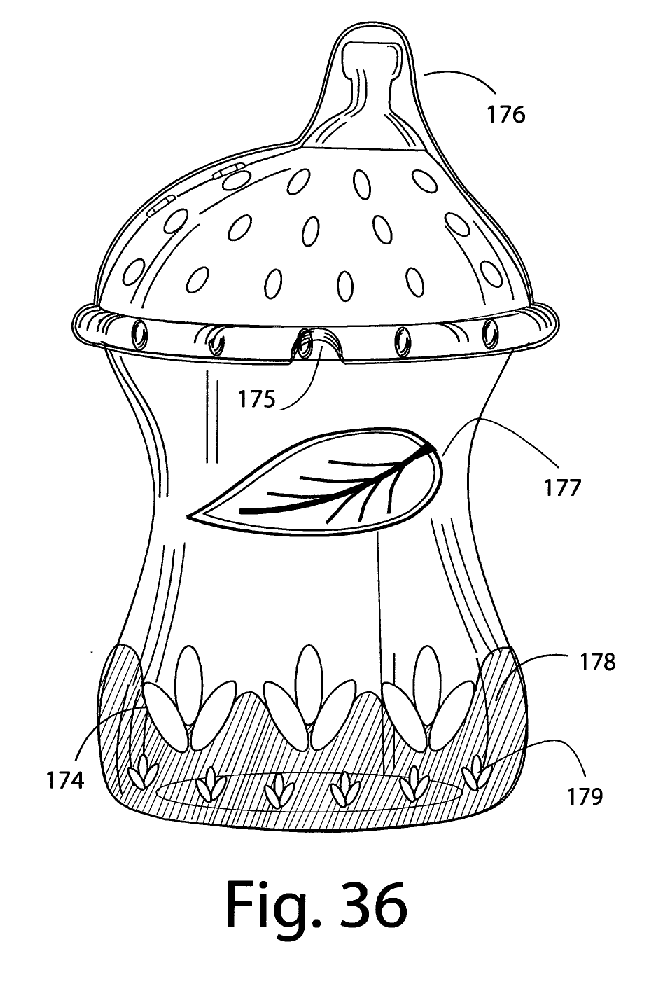

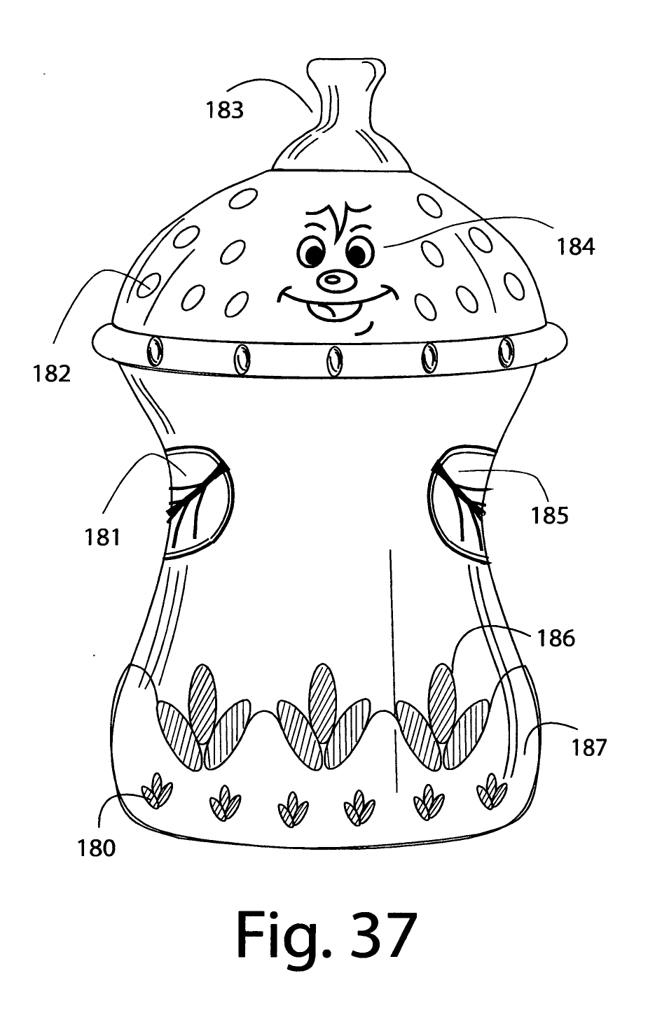

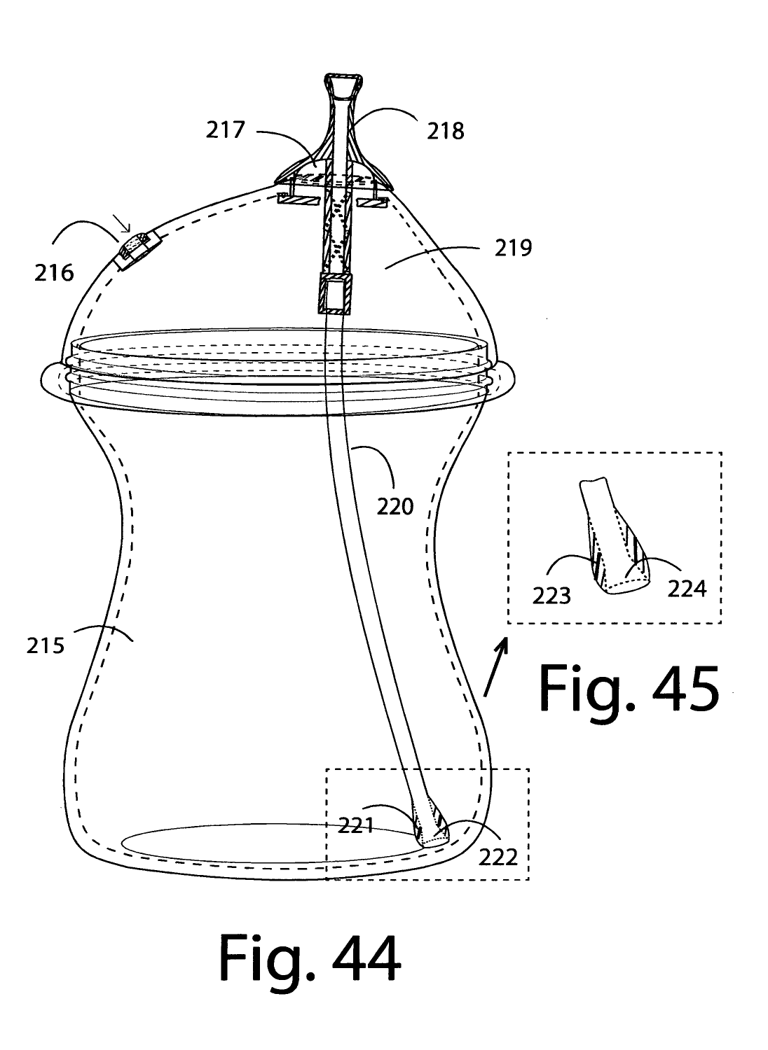

Now referring to FIGS. 1 through 40 and FIGS. 50 through 53 a novel Medicup an oral medicine dispenser is shown with its embodiments according to the present invention. The molded cup 10, 19 also 215 in FIG. 44 formed as separate unit preferably of transparent or extremely translucent thermoplastic material or other safe suitable material, so the amount of consumed liquid can be seen and controlled independently. A similar drinking cup 215 in FIG. 44 is made for the Strawcup.

The Medicup and the Strawcup and all its components/embodiments are made of durable, color fast, dishwasher safe, resistant to breakage, BPA and phthalate free, safe for user materials, with no sharp edges. Some of the decorative components such as stars, ovals, happy face and leaves are made of soft, dishwasher and user safe material. The drinking cups assemblies preferably formed from flexible polypropylene. The removable soft drinking devices are formed of silicone.

The valve assembly 74 and 82 is made as a separate unit of safe for user preferably opaque thermoplastic material.

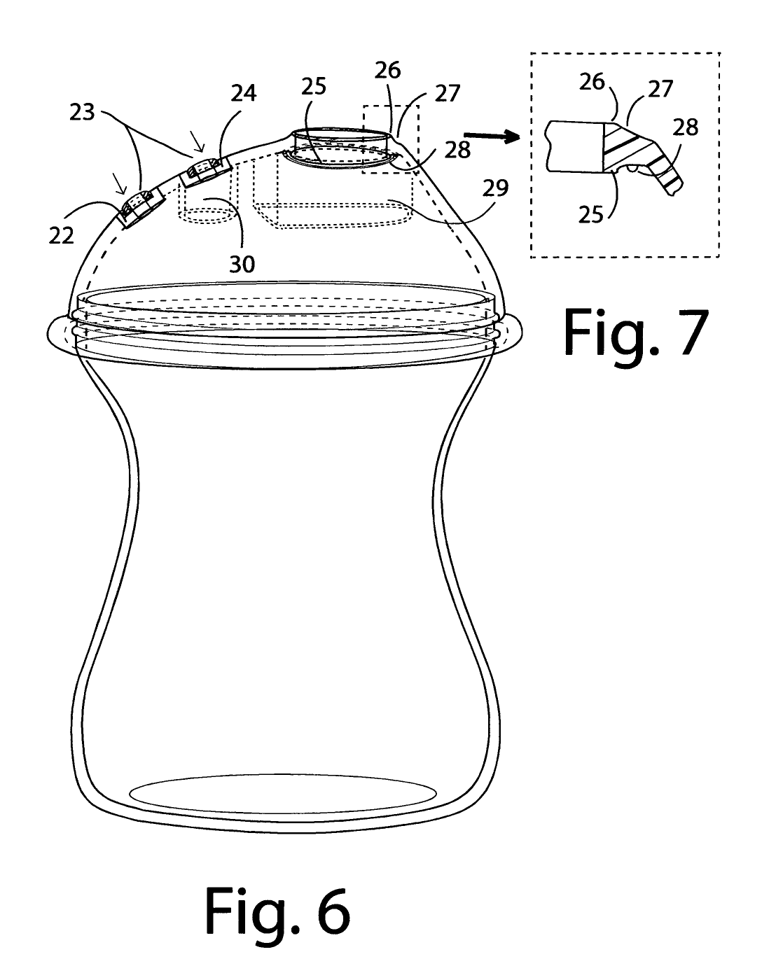

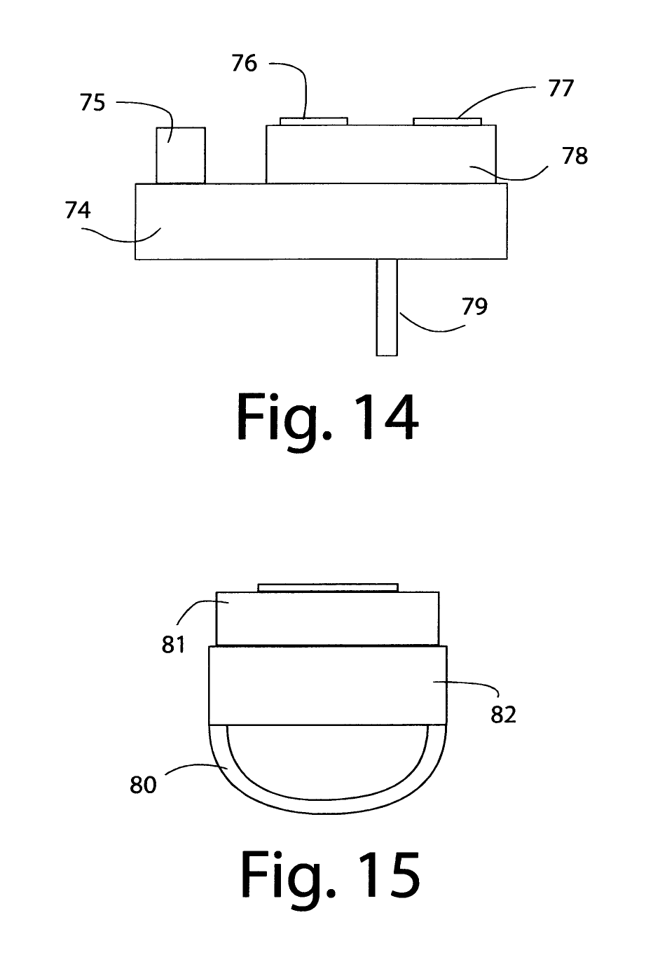

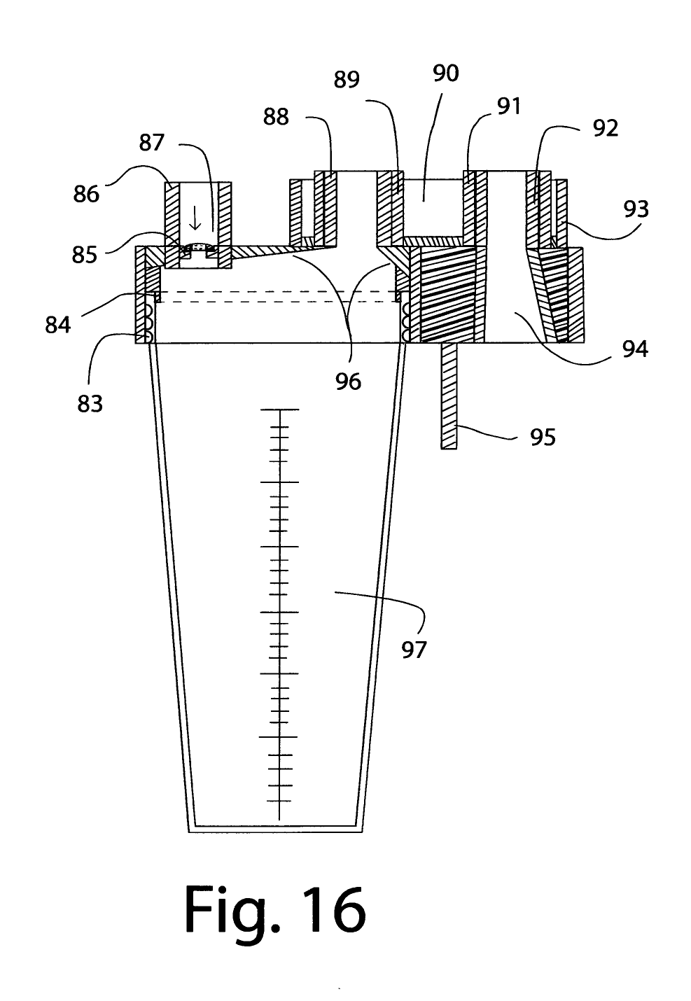

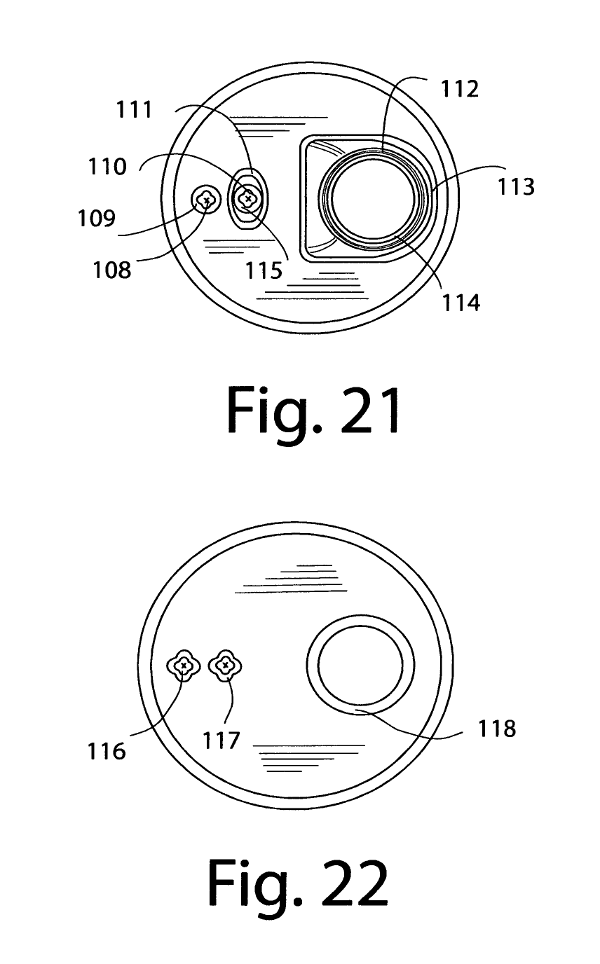

The lids 13, 20, 219 formed preferably of opaque or clear thermoplastic material or other safe suitable material. FIGS. 13, 16, 20, 29 and FIG. 30 a molded medicine cup 73, 97, 107 representing a holding medicine container 150, 151 also formed as separate unit preferably of transparent, clear, safe plastic material. The preferred configurations of the lid 20 are molded components/adapters formed as one unit 29, 61 and 30, 57 in FIG. 13 with the lid. The two said adapters forming two cylindrical tubes 29, 30 in FIGS. 6 and 57, 61 in FIG. 13 also 111, 113 in FIG. 21 preferably constructed, arranged and formed during lid's molding and sized to receive the valve assembly's adapters 75, 78, 81 in FIGS. 14, 15 also 135, 138 in FIG. 26. The valve assembly connected to the lid by a snap fit engagement of two outer flanges/adapters of the valve assembly 75, 78, 81, 86, 93, 135 and 138 with the lid's adapters 29, 30, 57, 61, 75, 78, 81, 111 and 113 in FIG. 21 to retain the valve assembly on the lid for dispensing of liquid medicine and tightly seal around it.

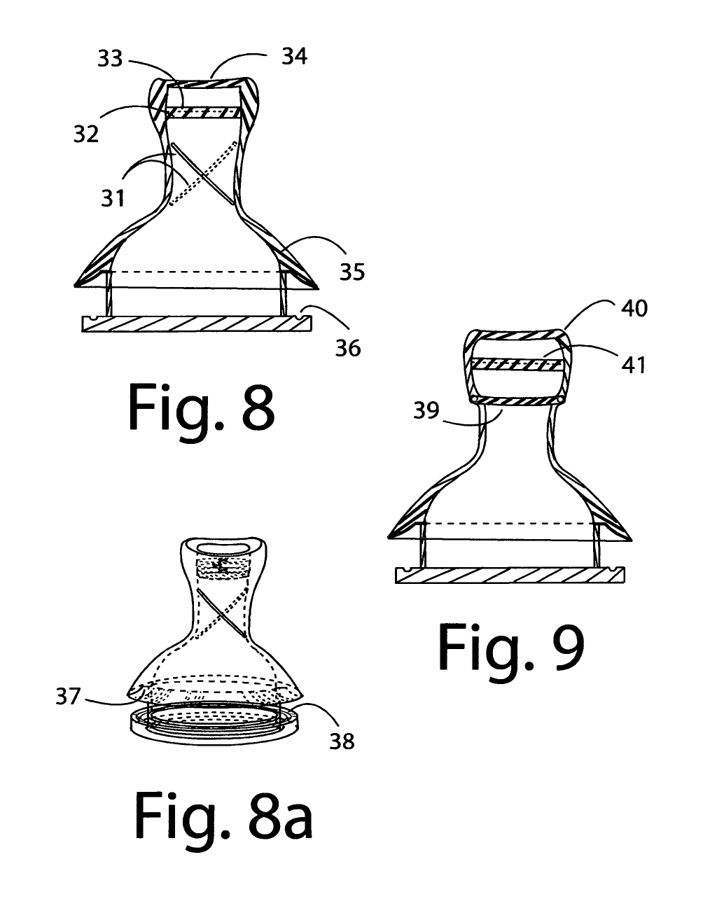

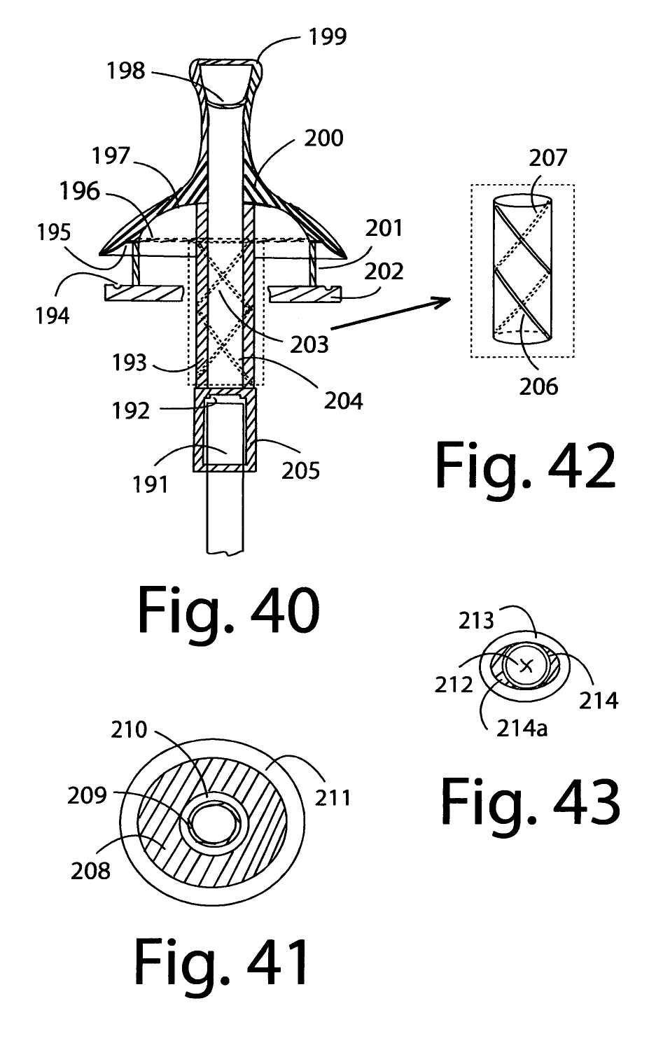

The Strawcup is similar to the Medicup in design with the exception of an empty space inside of the lid 219 in FIG. 44 formed by molding as a separate unit preferably of opaque or clear thermoplastic material. The lid's upper mouth/opening 64 in FIG. 6 and FIG. 13 constructed and formed of similar shape and size for the Medicup's and the Strawcup's lids. The said mouth/opening 64 in FIG. 6 and FIG. 13 constructed, arranged and formed with annular rims 25, 26, 65, 114 and 118 in FIGS. 21, 22 on its external 26, 118 and on internal 25, 65, 114 sides which is configured to receive and tightly fit with the soft drinking spout 35, 40 and 53 in FIGS. 8, 9 and 12 or the soft drinking straw 200, 218 and 239 in FIGS. 41, 45 and 49.

All soft drinking devices such as; a soft spout, a soft straw, air vent's soft members and soft handles assembly are preferably made from medical grade silicone or similar flexible, easy to clean and harmless to children or other user material; also the drinking devices (soft spout and soft straw) can be sterilized by boiling for example. The soft drinking spout 35, 40, 53, the soft drinking straw 200, 218 and 239 and the soft handles assembly are preferably molded as one separate unit from flexible, clear preferably colored material.

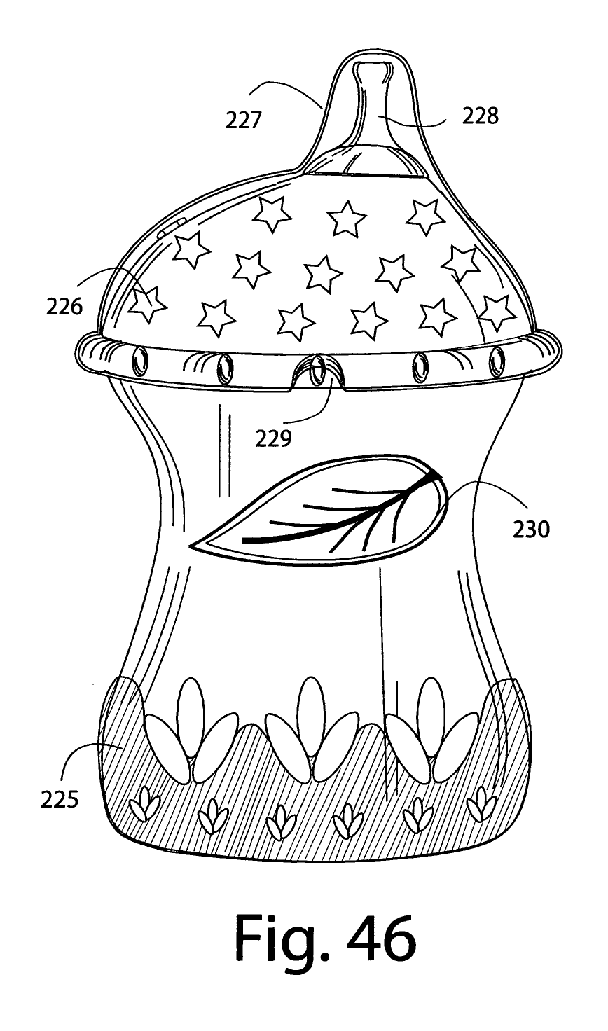

A flexible straw 220 in FIG. 44 preferably made as one unit of clear or transparent, safe, flexible plastic material. The plastic straw's distal end molded with funnel-shaped 221, 223 interior walls and curved weighted outer sidewalls 222, 224 in FIGS. 45, 46.

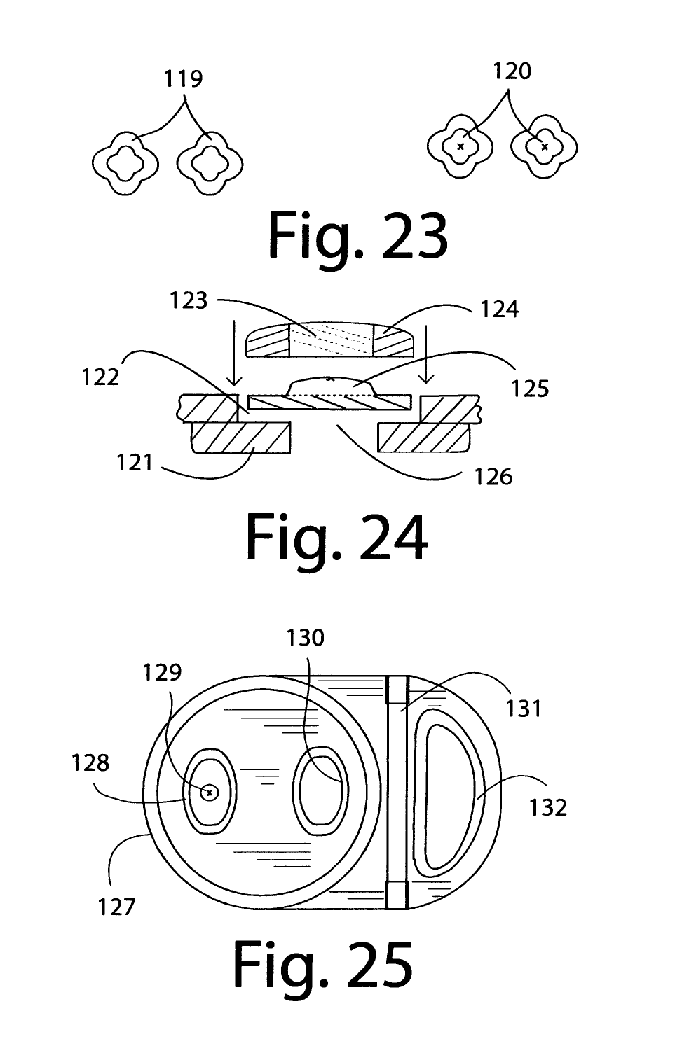

The two air vents 11, 23, 59 and 108, 110 in FIG. 21 also 116, 117 in FIG. 22 are located on the Medicup's lid and one air vent 216 in FIG. 44 on the Strawcup's lid. Each valve comprises of two separate pieces of structure; one is a hard ring made of decorative shape plastic 119 and another soft flexible member 120. The decorative hard ring 119 made of opaque thermoplastic material formed in decorative shape with four rounded ends as shown in 119, 120, 124 in FIGS. 23, 24 with air opening 123 in its center designed to cover silicone member 120, 125 and 133 in FIG. 26 and permanently air-tight seal at its edges. The hard ring 119 protruding less than 1.5 mm above the lid's surface is positioned (shown by two arrows) along with the silicone member 120, 125 into a ditch 122. A hard ring protruding inward 22, 24, 58, 109, 115, 121 in FIGS. 6, 13, 21, 24 forming the said ditch with centrally located air opening 126 is preferably formed during molding.

The third air vent 60, 87, 101 is located on the valve assembly inside of the left oval tube/adapter 57, 75, 86, 102 and 135 in FIG. 26 formed in similar way as said two air vents made on the lid but with the exception of the rounded shape of the hard ring 105 in FIG. 19. The hard ring 101 along with silicone member are permanently and tightly mounted into a ditch on top of the said protruding inward ring 85, 103, 121, 129 in FIGS. 16, 18, 24 and 25 covering the said air opening.

All air vents have “x” or “x-wavy” slits with the length of the slits approximately 0.05 to 0.17 inches in diameter located in the center of each silicone member.

I assume that I am not bounded by these dimensions and that the slit size and shape can be adjusted later on to the necessary and appropriate size and/or shape for adequate air supply of the Medicup, the medicine cup and the Strawcup.

A lid's cover 243 in FIG. 49 made of transparent or clear flexible, safe plastic material.

The cylindrical tubes 144, 147 in FIG. 27 with slits made of silicone or soft flexible material to cover the upper opening of the medicine dispensing duct 143 and upper opening of the conduit for liquid beverage 141 are intended to control liquid flow and spill. The plastic tubes 148, 149 in FIG. 28 are formed to fix permanently silicone members 144, 147 to the medicine dispensing duct's sidewalls 137 and to the conduit's sidewalls 139 in FIG. 26 located on the valve assembly and preferably made of safe, opaque thermoplastic material.

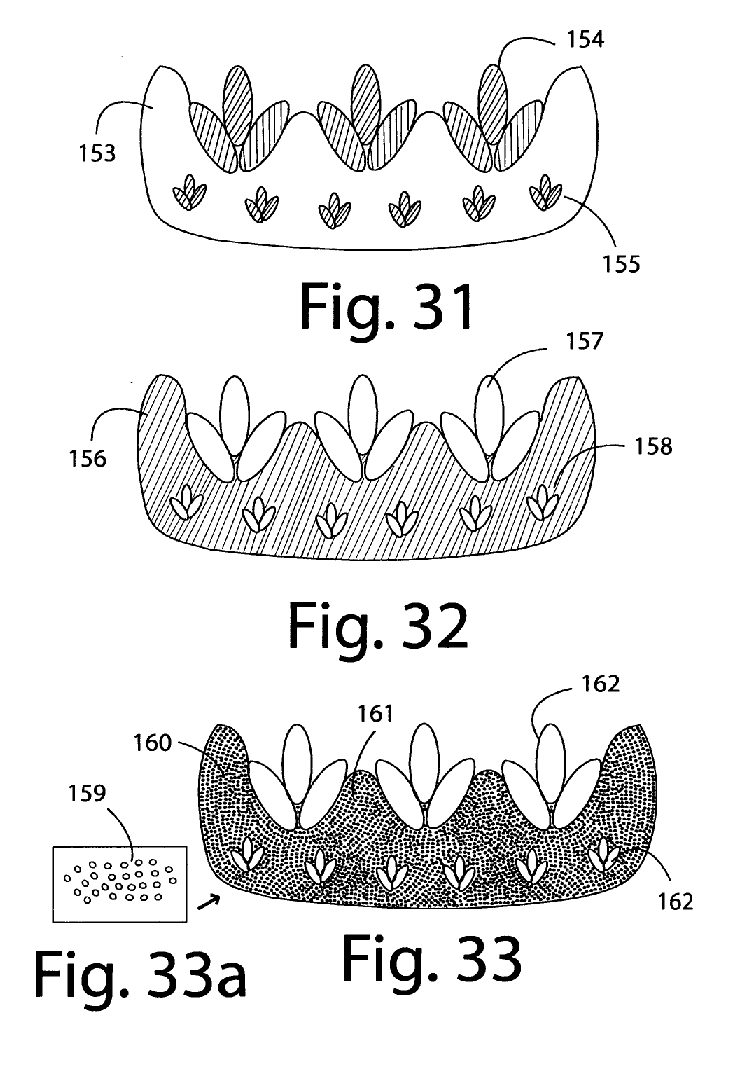

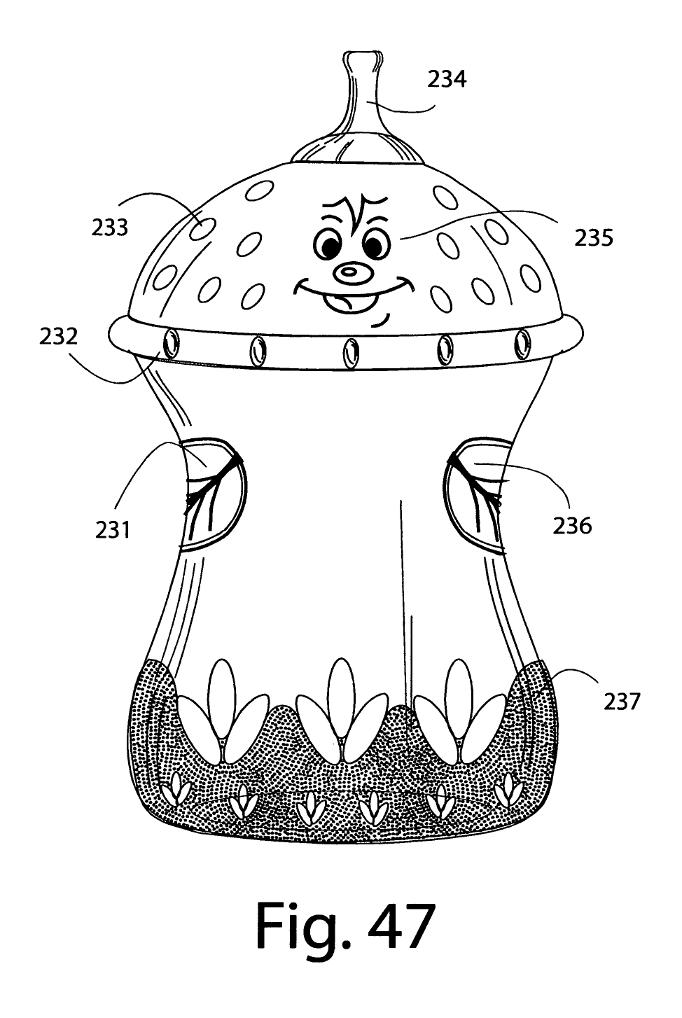

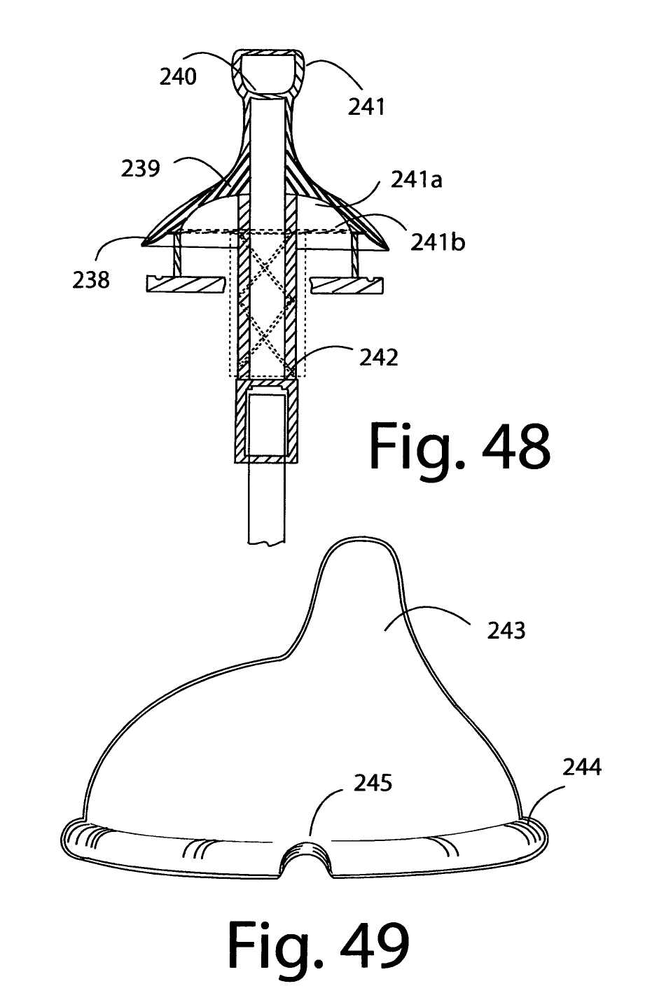

A variety of ornamental attachments 189 in FIGS. 39 and 153, 156, 161 are designed for decorative purposes of the bottom of the cups in FIGS. 31, 32, 33, 47, 48 and FIGS. 34 through 37 preferably made of combination of opaque or clear thermoplastic 153, 156, 157, 158 and soft materials 154, 155 or other suitable material. The goal is to make some parts of the decorative elements of different colors, therefore it will be determined later which part(s) will be made of plastic and which of soft material/s. Another ornament made of minuscule/tiny size 159 in FIG. 33a, slightly protruding ovals 159, 160, 237 and 161, 162 preferably made of clear or opaque thermoplastic or combination of plastic and soft materials or other suitable material. An ornamental attachment 189 comprises an opening 190 in its center.

The drinking cups can be made with other ornaments or printed with different decorative elements or can be decorated with frosted surface on the decorative attachment's sidewalls.

The ornamental attachments 189, 153, 156 and 161 preferably made of thermoplastic material and/or soft material or the ornament can be printed on a drinking cup's body.

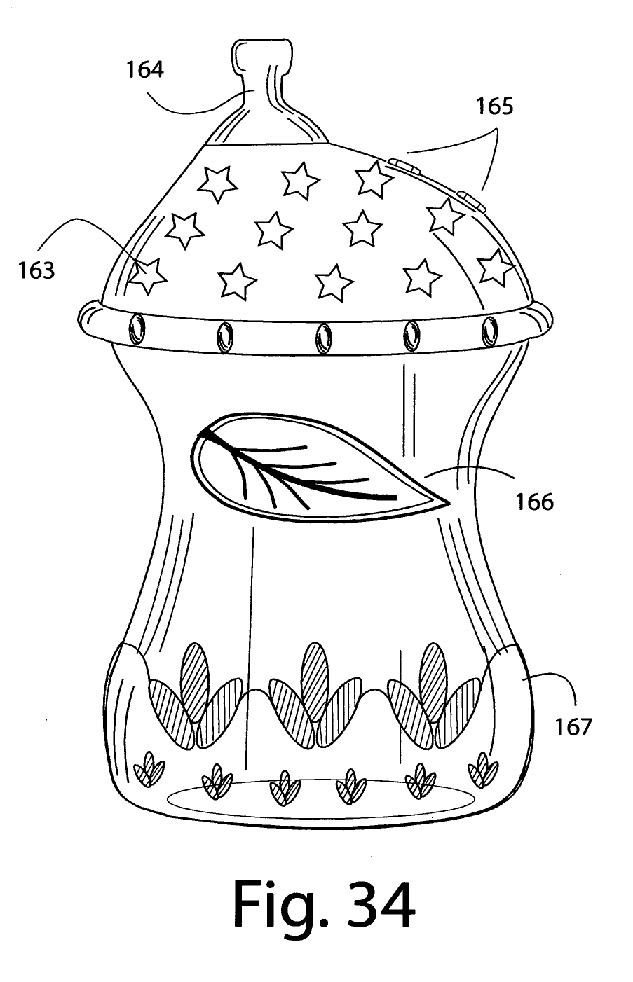

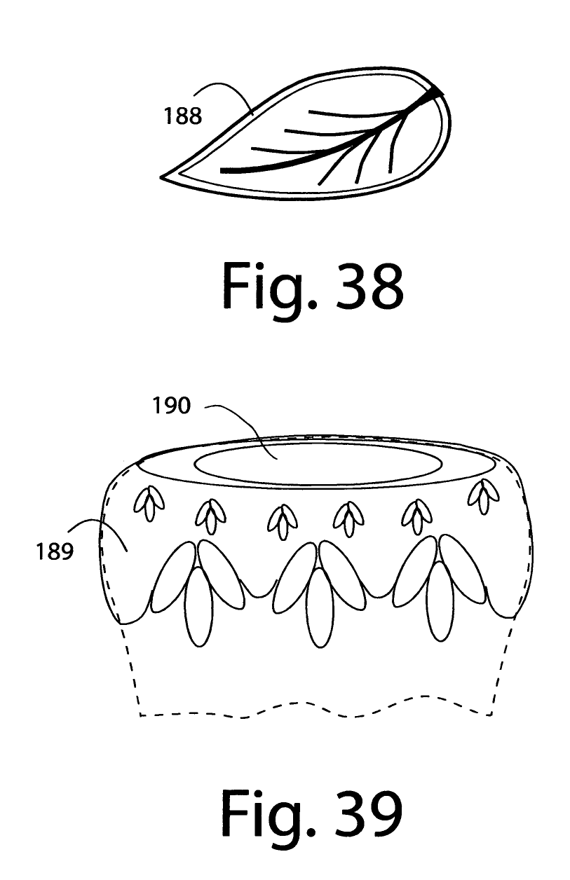

The leaf 188 in FIG. 38 and the lid's ornamental decorations in the form of stars 163, 226, ovals 182, 233 and happy face 171, 184 and 235 in FIGS. 34 through 37 and FIGS. 47, 48 are made for decorative purpose preferably made of soft material safe for the user. However, the happy face 184 the stars 163 and the ovals 182 could be printed. Additionally, the soft leaves 169, 172, 181, 185, 231 and 236 are provided in gripping areas of hard cups which help to hold the cups more securely.

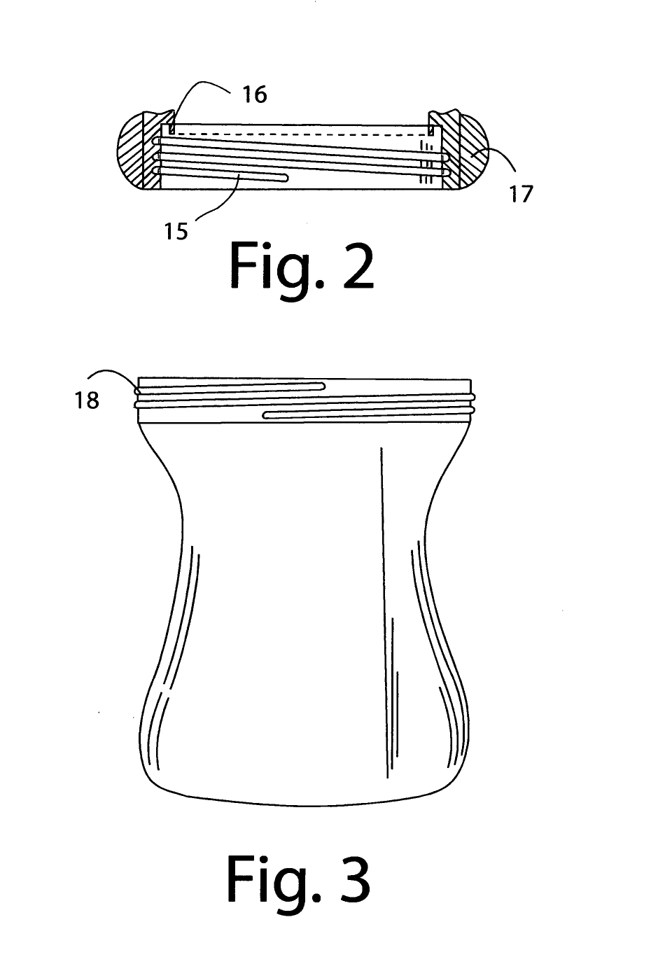

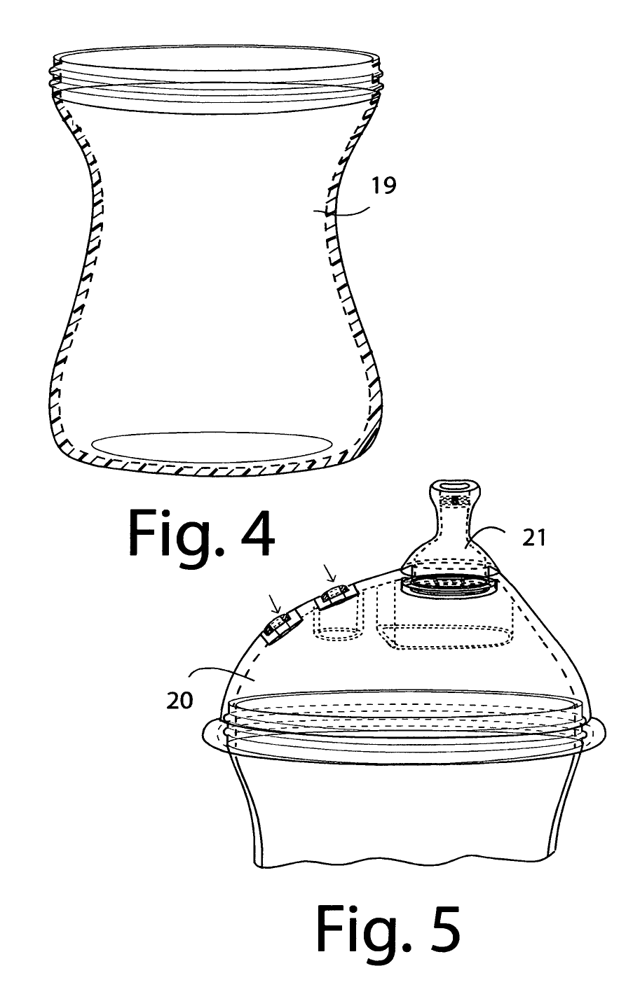

Referring to the drawings more in detail and particularly reference to FIGS. 1 through 4 where some preferred embodiments of the present invention are shown. The body of a drinking cup 10, 19 has hollow cavity for holding a liquid beverage prefilled through its upper mouth/opening as seen in FIGS. 3 and 4. The Medicup's lid 13, 20 contains two leak-free air vents 11 and 23 in FIG. 6, a detachable soft drinking spout 12 and slightly protracted ovals defining finger grips 14 and 232 located on the lid's bulging distal edge 17 shown in FIG. 2 which is designed to assist in handling of the lid for screwing and unscrewing the lid on or off the cup.

The lid is a screw-on cap which can be easily rotated onto the drinking cup. It has usual mating screw threads or peripheral groove 15 shown in FIG. 2 sized to receive an upper rim 18 of the Medicup's or Strawcup's drinking cup and as usual air-tight seals around its rim. To recap, the lid formed with annular flange 15 formations which fit a circular rim of the cup 18, allowing the lid to rotate. The screw-on lid can be provided with a gasket between the cup and the lid to seal the connection between the cup and the lid, or the lid is provided with a small annular inner lip 16, on the inside of the lid acting as a gasket. The lip wedges inside the lid when it is screwed and prevents leaking of liquid.

FIGS. 5 through 13, the soft drinking spout 21 is designed to fit the lid's open mouth/opening 64 and tightly seals around its annular ring 28 to prevent leaking. The drinking spout's body 35 is connected with an elongated neck 53 and with projected rigid sidewalls 54, slightly concave 34 on its tip's sides but slightly convex on its front and back upper sides 40, 56. The spout's tip 45 and 47 forming projecting outwardly rigid sidewalls 40 and 54 with dispensing opening 32, 33, 41, 45 and 46 are positioned within its inner sidewalls. The elongated neck 53 has diagonally and slightly protruding inward one rigid fold 31 on each side of the spout which helps along with rigid valve's sidewalls 32, 41, 43, 48, 255, 263 to prevent collapsing of the spout's neck sidewalls 53 during suction, however, not too rigid to prevent compression and withdrawing of liquid. The spout's body 35 comprises of bulged sidewalls made of silicone and rigid edge on its rear side 37 to tightly fit lid's mouth rim 25, 26 and curved in on its lateral side 27 as seen in FIGS. 6 and 7. An annular flange 51 along with annular u-shaped ring 36, 38 adapted to engage the lid's rim 25 and annular ring 28, 112 for tight sealing. The spout 54 has a hollow interior 55 connected with hollow upstanding neck 53. Each of two drinking spouts 34 and 40 has oval shape 45, 46 apexes with rigid sidewalls.

All dispensing valve/s 43, 48, 247, 255 is/are formed with rigid sidewalls and thin flat surface made of silicone 44, 49, 251, 253 and 256 covering each valve. The valve/s molded in the depression positioned inside of the spout's upper sidewalls 33 and 41 in FIGS. 8, 8a and 9 in the apex area placed not too deep 32, 33 approximately in the center or closer to the apex/opening for easy cleaning purpose 32. A sill provided between valves to connect the outer surfaces of its sidewalls 42, 50, 246 and 252 to the outer surfaces of the spout's sidewalls 248, 250 and between each valve 42, 50 and 252 to prevent the valve/s from inverting and pulled out of the spout's body of the spout during drinking of liquid. Additional material may be provided to make valve/s stronger to prevent inversion.

The soft drinking spouts and the soft drinking straws are made of non-uniformed walls which are not too flexible to prevent collapsing of walls during drinking or sipping of liquids and not too rigid to make withdrawal of liquids from the cups too difficult. Darker lines in FIGS. 8, 9, 12, 40 and 48 represent rigid areas of the soft spouts and soft drinking straws formed from silicone. The silicone hardness can be used between 40 to 60 durometer (Shore A) but preferably, the silicone used for soft drinking spout, soft drinking straw and soft handles assembly has (Shore A) 45 durometer hardness and/or used low and high durometer to achieve necessary firmness/rigidness of some specified areas. The soft spout, the soft drinking straw and the soft handles assembly are made preferably during conventional molding for example injection molding or compression molding, etc.; however, liquid injection molding (LIMS) of silicone is preferred.

Another spout, a variation of the previous said soft spout 34 is presented for the current invention comprises distended outer sidewalls with similar oval shape rigid tip/apex at its upper portion 40 and a bump 39 on its end. The bases of both spouts as shown in 35 are made in the same way with rigid silicone edges on its rear sides 37 for tight engagement with lid's mouth 64.

The said bump 39 forms a rigid ring made of silicone (but not too hard to prevent compression of the sidewalls and restrict child's ability to withdraw liquid from the cup) positioned during molding into a low area of distended walls of the second drinking spout. It allows child's teeth to hold the spout better when they naturally bite down the spout's outer walls during drinking; also said bump will help to prevent collapsing of walls.

Each spout 34, 40 is designed and formed to be mounted on top of the lid. Both soft drinking spouts have elongated necks 53 and its apexes are made with one of four presented openings 45, 46, 247 and 255 with non-leaking dispensing valve/s. Each opening comprises from one to four of different shape rigid valves 43, 48, 249, 254 and 257 as shown in FIGS. 45, 46, 51 and 52 with slits in its center 44, 49, 251, 253 and 256. The valves are connected to the spout's inner sidewalls and between each other 42, 50, 248, 250 and 252. Shaded surface 47 and 246 represents a thin layer 33 of silicone membrane covering space between valves 48 and around the valve 249.

All said dispensing valves consisting of thicker, rigid sidewalls 32, 41 42, 43, 48, 50, 249, 254 and 257 designed and formed to prevent collapsing of the spout's walls and inversion of the valve/s during applied suction. The said valves with “x” or “x-wavy” shaped slits or cross cut of two intersecting slits, with each slit length of approximately 0.127 inches up to 0.138 inches.

Any other types of opening/s or slits can be used for medium, fast and/or extra fast flow, including combination of different slits, holes etc. which can be adjusted later on for required liquid flow rate and for child to be able to drink beverage without too much force.

I also assume that I am not bounded by these dimensions and that the slit's size and shape can be adjusted later on to the necessary and/or appropriate size and/or shape for the adequate liquid flow from the drinking spouts 34, 40, 54 of the Medicup and/or soft drinking straws 199, 218, 241 of the Strawcup. Also, if necessary to adjust dispensing slits on the valve assembly 142, 140 constructed to provide communication between soft drinking spout and medicine and drinking cups allowing children to drink liquid.

In the following detail description reference needs to be made again to the drawings in FIGS. 13 through 30, where are disclosed preferred embodiments of the valve assembly with all its members.

One of the members of the valve assembly 74, 82 and 93 is an upper semi-cylindrical shape valve/adapter 69, 78, 81, 90 and 138 structured and formed to fit the lid's 61 and 113 cylindrical structure/adapter with hollow space inside, playing additional role as a receptacle 69, 90 which surrounds the medicine dispensing duct 63, 76, 88 and 143 and the conduit 68 for liquid beverage 77, 92 and 141. The medicine dispensing duct consist of oval shape cylindrical structure 143 covered by silicone member 137 with dispensing slits 142 which is used to dispense medicine to user through the soft spout. The conduit 141 for liquid beverage consist of semi-circular shape cylindrical structure 141 covered by silicone member with dispensing slits 140 and used to dispense liquid beverage along with medicine to user through the soft spout. The silicone members 144, 147 with “x” or “x-wavy” shaped slits 140, 142, 145 and 146 in the center permanently fixed by hard rings made of plastic 62, 70, 89, 91, 136, 137, 139, 148 and 149 and formed of similar to corresponding tube's shape. Such feature is advantageous which prevents mixing of liquid medicine with liquid beverage, but in case of back flow the mixture is collected in the open receptacle 69, 90. The mixture disguises the taste of child's unfamiliar and undesirable medication. Both the medicine duct and the conduits 88, 92 point towards the soft spout and provide communication between the soft drinking mouthpiece 21 and the drinking cup's contents/liquid through the space between them. The valve assembly along with soft spout permits liquid beverage and medication to be dispensed into the user's mouth concurrently.

The second member located also on the upper left side of the valve assembly 74, 82 is an oval cylindrical structure/adapter 75, 86, 102, 135 which provides additional support for the valve assembly to retain it on the lid 57. The said adapter 75, 86, 102, 135 designed and formed to supply air into the medicine cup 73, 97 through air vent as shown in FIG. 24 located on the lid 59 and another air vent located on the upper surface 60, 87, 101 and 129 of the valve assembly 74, 82. The arrow shows the air vent 87, 101 placed in the cavity made in the valve assembly 85, 103, 122.

The third member and preferred embodiment of the present invention 83 located on the distal left end of the valve assembly is a valve 127 comprising a closure for a medicine cup 73, 97, an air vent 129 located within extended tube 128 and the medicine duct's opening 130. The valve have inclined upper/ceiling surface and sidewalls 96 to help collecting of all liquid medicine from an inverted medicine cup 73, 97. The liquid medication flows from the inverted medicine cup 63, 88 through the opening 130 towards the drinking spout 21 for dispensing into a mouth of a child. The closure has an annular flange 84, 99 and peripheral groove 83, 98 formations which fits 71 a circular rim 106 of the medicine cup 107 allowing cup to rotate and air-tight seals around its rim.

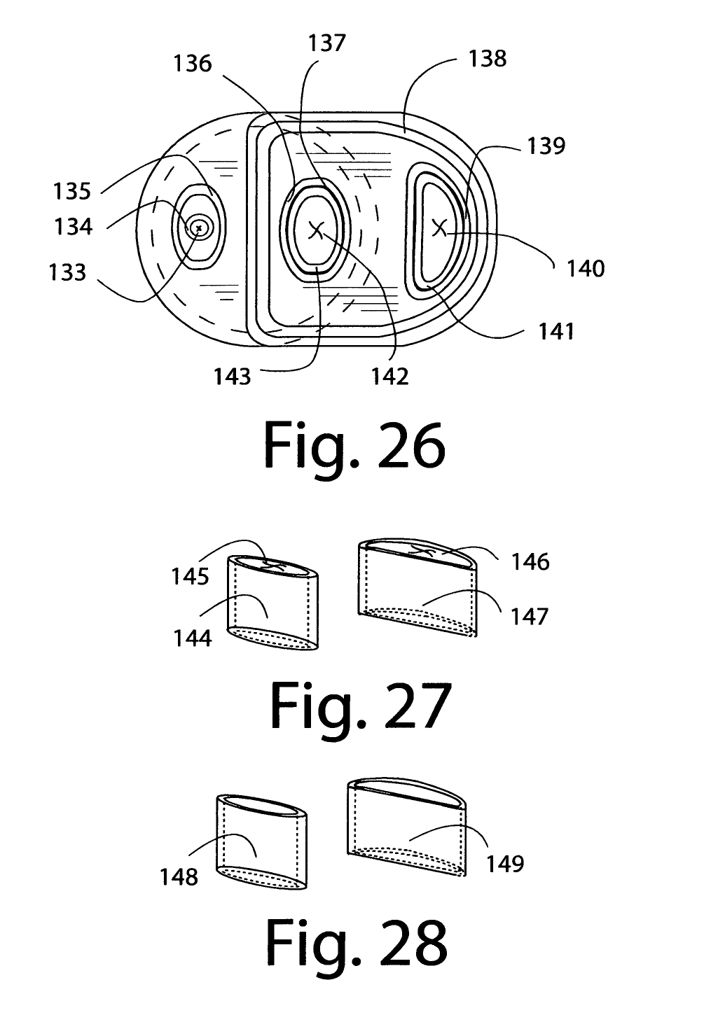

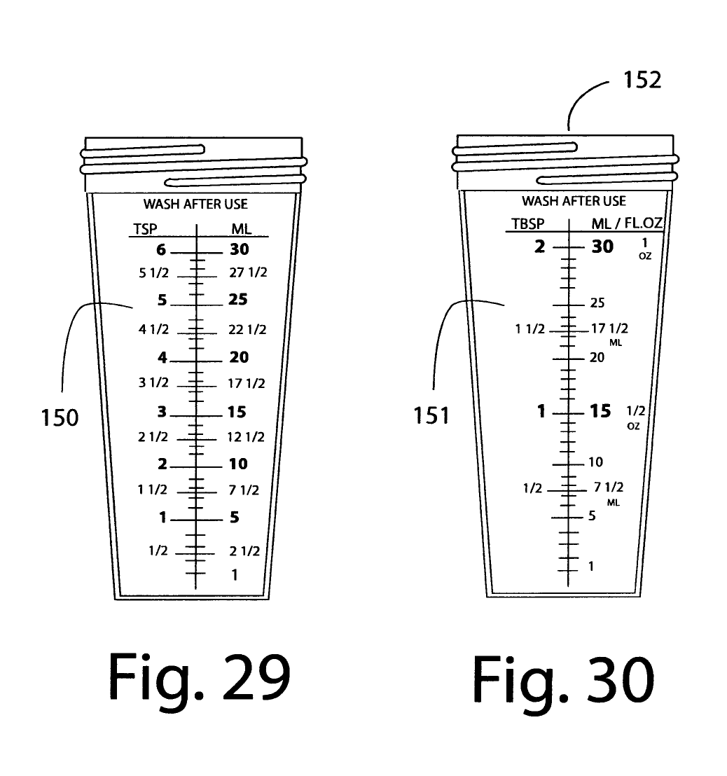

The fourth member of the preferred embodiment is a medicine cup 107 with easy-to-read graduations 150 and 151 designed to hold and dispense medicine. It is formed to have an open mouth 152 at the top of the cup 107, 150, 151 where precise amount of medicine can be poured inside of its cavity and dispense to user in steady flow rate through dispensing opened duct 130 in FIGS. 25 and 63, 88 in FIGS. 13, 16 and soft drinking spout. The size of the medicine cup is 30 ml/cc of capacity plus extra at least 0.5 cm empty space to prevent spilling of medication during connection of the cup into a closing valve.

The fifth members and preferred embodiments located on the right distal area 94 of the valve assembly are the semi-circle shape opening of the conduit 94, 132 for liquid beverage constructed of larger size for easy cleaning than its upper extension 68, 77, 92, 141 and the small handle 72, 79, 80, 95 and 131 to assist in handling of the valve assembly 74 during insertion into the lid's adapters 30, 57, 29 and 61 and removing it.

Referring now to FIG. 31 through FIG. 39, also FIG. 46 and FIG. 49, where disclosed other embodiments of the present inventions the ornamental attachments 153, 156 and 161 which are made for decorative purpose of drinking cups 167, 187, 189, 225 and 237 preferably of opaque thermoplastic and formed during molding of said ornaments 153, 156.

The second attachment 156, 168, 178, 225 with leaves 157, 158, 174 and 179 are made of soft material or thermoplastic covered with soft material or made of combination of different materials to show different colors of the base and the leaves.

Third ornamental attachment made of minuscule size 159 in FIG. 33a, slightly protruding ovals 160, 162 and 237 and leaves 162 in FIGS. 33, 33a, 48 preferably made of clear or opaque thermoplastic or combination of plastic and soft flexible materials or other suitable material.

The ornamental leaves 154, 155, 166, 169, 172, 177, 181, 185 and 188 for the hard drinking cup are made of very soft, safe material. The decorative soft leaves, the stars 163, the ovals 182 and the happy face 171, 184 are made on the Medicup's lid and cup in similar fashion as on the Straw cup 226, 230, 231, 233, 235, 236. All decorative elements needs to be made of different colors, therefore, it will be determined later which part is to be made from plastic or soft material or vice versa.

The lid's cover 176, 227 resembles the lid 244 contour with attached spout 176 or soft drinking straw 227 made of clear, flexible plastic material. The said cover 176, 227 contains arched, protruding outwards grip 175, 229, 245 with a space enough to insert fingertip for easy removing of the lid's cover 176, 227 and 243 is formed during cover molding.

Generally, since the soft drinking spouts 40, 53 have elongated necks and the soft drinking straws 200, 241 are a little bit longer than the soft spouts only one mold of lid's cover is made to fit both the Medicup's lid 176 and Strawcup's lid 227, 228.

Also, only one mold can be made for both Medicup and Strawcup drinking cups 10, 19, 215; however, each cup's bottom is decorated with one of three suggested ornamental attachments.

Two externally similar in size and shape lids 20 and 219, one for the Medicup and one for the Strawcup are formed and molded with similar shape and size mouth/opening 64.

The main difference between the two lids is that the Medicup's lid 20 has two leak-free air vents 23, 116, 117 and two additional cylindrical structures/adapters 29, 30 for retaining of the valve assembly 74, 82, 93 but the Strawcup's lid 219 has only one leak-free air vent 216 and has an empty space inside 219. The mouth/opening 64 of each lid is constructed and formed of analogous shape and size for tight engagement with the soft drinking spout 40, 53 or the soft drinking straw 200, 241. Both lids are decorated with one of the suggested ornaments; the stars 163, 226 or the ovals 182, 233 and the happy face 171, 184, 235. As well, each lid might have other decoration or not have any.

Now referring to the drawings in FIG. 40 through FIG. 48 in more detail, where are disclosed and described two soft straw mouthpieces 199, 218, 228, 234 and 241. The soft straw mouthpieces 199, 241 are drinking devices disclosed here which are made of silicone or other soft safe material preferably by molding as one unit.

Each soft straw mouthpiece defines the soft drinking straw 200, 239 with leak-free opening 213. It consist of an upper opening 199, a neck 200, 239, a base with hollow space 217 between upper wall 197, 241a and membrane 196, 208, 241b, sidewalls 201 and annular flange 202 constructed to fit and support the soft straw's structure inside of the lid's mouth/opening 64. The drinking tip/apex 213 contains a leak-free valve 198, 214, 240 formed with rigid sidewalls with “x” or “x-wavy” slits in the center 212 and fixed with silicone member 196, and 214a to the soft straw's sidewalls. Both soft drinking straws are formed and molded with non-uniformed walls. The bases 200, 239 of both soft drinking straws are formed from rigid silicone to support its extended distal soft straws 193, 242 which are depicted by darker lines in FIGS. 40 and 48.

The said soft straw apex's sidewalls 199, 241 is formed in an outwardly projecting position comprising a drinking opening 198, 213, 214, 240 in the depression positioned and formed within its inner sidewalls. The depression 198 forms a flat surface with annular valve 214 in its center. The said valve consist of rigid sidewalls and “x” or “x-wavy” slits 212 for dispensing of liquid from the soft drinking straw along with attached flexible plastic straw. Bulging sidewalls 200 continues underneath 195 of the base where its edge is made of rigid silicone. It is formed and shaped to fit and tightly engage with the lid's mouth/opening 64, 118 and 219. The soft straw's annular flange 202 molded with an annular u-shaped ring 194 is formed for air-tight sealing around the lid's annular disk 28, 67 and 112. Additional seal and/or material may be provided to complete the soft drinking straw's structure/assembly.

Each soft drinking straw/mouthpiece 200, 241 towards its distal end continues with extended soft straw 193, 242 made of silicone with two diagonally protruding outward rigid folds on each side 203, 204, 206, 207 but with flat internal surface for easy cleaning. The rigid folds will help to prevent collapsing or extensive bending of the soft distal end which otherwise will make difficult to withdraw liquid from the cup. The distal opened end/mouth 205, 210 of the said soft straw 193, 242 molded with internal small ring 192, 209 and formed to prevent the attached plastic straw 191 from moving forward.

Both soft drinking straws are made of non-uniformed walls with some rigid areas.

The area made of rigid silicone is the end of the base of the soft drinking straw 195, 238 formed to engage and tightly fit with the lid's mouth. A flexible, plastic, slightly curved straw 220 formed at least 6 mm in diameter with opened 222, 224 distal end. The said straw's distal end consists of funnel-shaped interior sidewalls and weighted curved outer sidewalls 221, 223. The weighted straw is able to move along with connected upper soft straw to the tilted cup's direction and helps user to collect most or all liquid from the bottom of the cup.

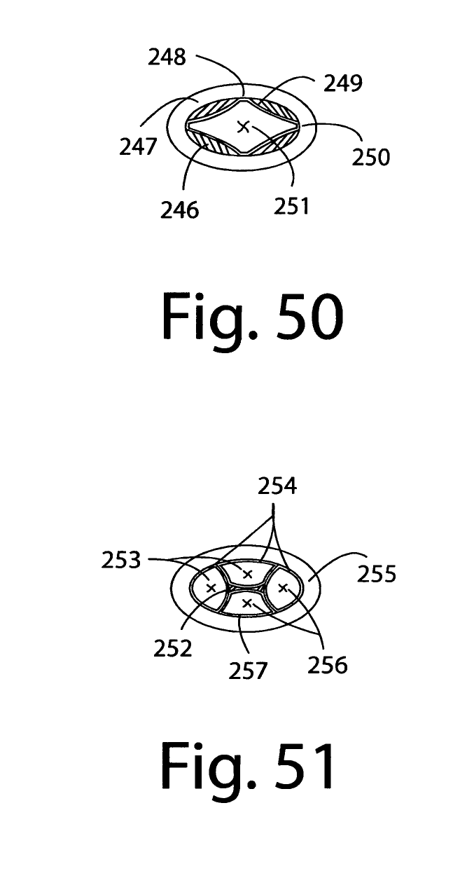

Two additional soft drinking spout's apexes/tips 247, 255 are shown in FIGS. 50 and 51 with one 255 or four rigid valves 254, 257 comprising one 251 or four 253, 256 slits/openings. Each apex/opening with one 247 or four leak-free dispensing valves 255 formed in the depression positioned within the soft spout's inner sidewalls made of silicone with rigid sidewalls and flat thinner layer inside and outside of each valve. One valve 250 or in case of four valves 254 and 257 each valve is connected to the spout's inner sidewalls 248, 250 and to each other 252. Each said valve comprising “x” or “x-wavy” dispensing slits is sized and dimensioned for adequately high liquid flow when infant, toddler or child drinking liquid from the spout.

All soft drinking spouts' openings are formed in the depressions positioned and molded in the apex's inner sidewalls with rigid dispensing valves and preferably formed during molding as one unit. Additional material or seal may be used where it is necessary. The valves rigid sidewalls formed for support and prevention of the valve/s to be inverted or pull out of the spout during suction/sipping process.

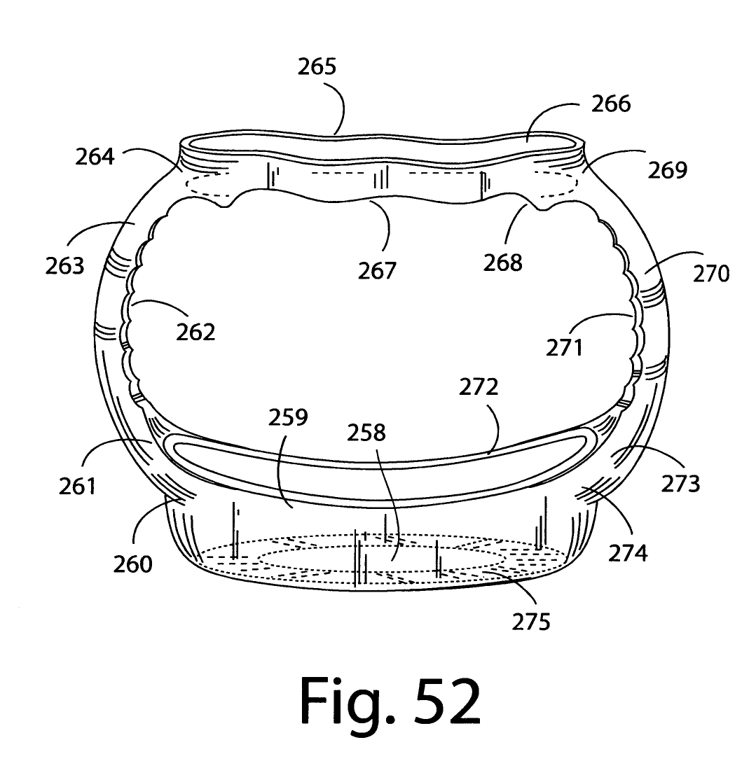

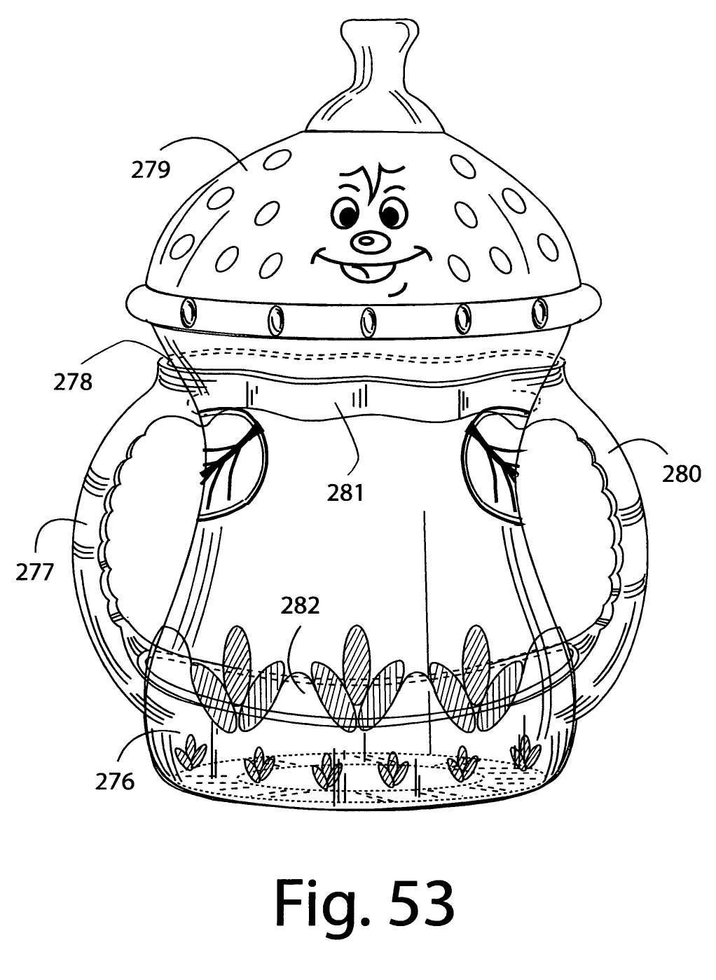

Referring now to FIG. 52 and FIG. 53, a soft removable Handle assembly 263 is shown in FIG. 52 made of combination of flexible plastic covered by preferably clear/transparent and preferably colored silicone or can be made of other suitable, safe for user material. It is structured and formed as opened configuration with upper mouth/opening 266, two handles 263, 270 and closed base 260 with an opening on the bottom 258. The structure/assembly is made of combination of flexible plastic and non-uniformed rigid and soft, flexible walls. The handles are made of flexible plastic covered by silicone 261, 263, 264, 269, 270 and 273 attached to the opened mouth/opening 266 made of silicone and to the base also made of flexible plastic covered by silicone 260, 275, 274. All structure are formed as one unit which helps to keep the structure intact, allowing good grip 277, 280, good support of a drinking cup and permitting only slightly stretching under the full cup's weight 279. The base 260, 276 on its lateral sides 261, 273, 274 where it is connected to said handles 263, 270 and its bottom 275 are made of flexible plastic covered by rigid silicone to support the structure but the base sidewalls 259, 272 and upper sidewalls 265, 267 consisting of soft flexible walls permitting stretching 278 and tightly fitting the drinking cup of the Medicup 279 or the Strawcup and its base 282, however, not too tight so user will be able to remove soft handles easily when it is needed.

The sidewalls 259, 267 are made of silicone or other flexible, suitable material which is able to stretch well allowing the Medicup 279 or the Strawcup 228 to be inserted inside of the handle's structure/assembly 263, 270 and tightly fit 276, 278 around its drinking cup 282. The base 259 are formed with concave upper rim 272. The sidewalls on its upper 265 and low 267 end form wavy shape rims 268 and 281. The internal sides of said handles 263, 270, 277, 280 formed with multiple curved in surfaces 262, 271 for finger grips.

The fully assembled Medicup with the valve assembly, prefilled drinking and medicine cup represents the medicine dispensing device which operates when user taking a spout into a mouth and while drinking of liquid from the spout continues.

The Strawcup operates when user takes the soft drinking straw into a mouth while sipping liquid from the drinking cup continues.

It is understood; that the description of my current inventions with regard to specific embodiments is not intended or meant to be limited and are not limited to the dimensions of shown and described here preferred embodiments since other modifications may be apparent to those skilled in the art.

This discloses the general principles with preceding detailed drawings and description of preferred embodiments of my inventions. Those skilled in the art will comprehend the advantages, improvements and modifications of the present inventions that showing in illustrative embodiments representing the disclosure of my inventions and my appended claims.

Subsequently, I do not anticipate that the details of embodiments described here will limit my exclusive rights and privileges of these inventions.

It is intended that the present application cover all embodiments and its modifications. Having to disclose and describe my inventions, what I claim and desires by Letters Patent to secure are:

1. A Medicup with its embodiments, a device for dispensing liquid medication along with liquid beverage to children, as shown and described.
An oral liquid medicine dispensing device for administering liquid medication to children comprising:
a drinking cup for holding liquid beverage, said cup having a threaded neck portion at the upper end that defines an opening within;
a lid, having threads in the interior distal portion of said lid that connects with the threads of said drinking cup;
two leak-free air vents with its hard and flexible members of said lid for ventilation into said drinking cup and medicine cup;
a graduated medicine cup for holding liquid medicine;
silicone members with leak-free dispensing slits covering an upper opening of a medicine dispensing duct and an upper conduit for liquid beverage; both permanently attached to the valve assembly for preventing mixing of liquid medicine and liquid beverage before and after they enter into drinking mouthpiece/spout or receptacle;
a leak-free air vent with its hard and flexible member located on a valve assembly for ventilation into a medicine cup;
a cylindrical structures/adapters located inside of said lid for retaining of said valve assembly and allowing dispensing of liquids;
a valve assembly constructed, arranged and dimensioned to fit within said lid's adapters for dispensing of liquid medication along with liquid beverage simultaneously when cup is inverted and drinking from a soft spout continues;
a lid's mouth/opening constructed and dimensioned to fit for tight engagement with soft drinking mouthpiece/spout and soft drinking straw;
ornamental designs for lids such as stars, ovals, happy face are made for decorative purpose;
three ornamental attachments for drinking cups and soft leaves are made for decorative purpose but the leaves also for easy gripping of the drinking cup;
soft removable Handles assembly designed for easy grip of Medicup and formed of flexible plastic covered by silicone or other flexible, suitable material;
a lid's cover made for Medicup fitting onto the top of its lid.

2. The dispensing device, as claimed and set forth in claims 1 and 2, further comprising:
the drinking cup is integral with the screw-on lid and all its preferred embodiments.

3. The dispensing device, as recited and claimed in claims 1 and 3, said screw-on lid is integral with said drinking cup and other preferred embodiments.

4. The dispensing device, as claimed in claims 1 and 4, the valve assembly with all its embodiments as shown and described is integral with the cylindrical structures/adapters of said lid. The valve assembly comprises of three valves and small handle. One valve supplies air through leak-free air vent into medicine cup and provides support and closure for said medicine cup. The said valve assembly with screw-threads inside of one of its left distal valve tightly connects with threaded neck of said medicine cup. The second valve contains adapter for retaining of said valve assembly on said lid, the medicine dispensing duct with “x” or “x-wavy” dispensing slits and the conduit for delivery of liquid beverage also with dispensing “x” or “x-wavy” slits. The third valve/adapter enclosed the air vent and provide additional support and help to retain the valve assembly on the lid. The medicine is dispensed when cup is inverted and user drinks liquid from the drinking spout.

5. The dispensing device as in claims 1, 4 and 5, said storage medicine cup having a threaded neck portion at the upper end that defines a mouth/opening within and it is integral with said valve assembly.

6. The dispensing device, as claimed in claims 1, 6 the storage medicine cup including graduations thereon for measuring the quantity of liquid to be dispensed from the soft drinking spout.

7. The dispensing device, as claimed in claims 1 and 7,
a) two leak-free air vents with x or x-wavy slits consisting of two parts; one made of decorative shape hard plastic and its flexible member is manufactured from silicone are integral with the screw-on lid of the Medicup;
b) the leak-free air vent for air supply to a medicine cup with “x” or “x-wavy” slits consisting of two parts one made of decorative shape hard plastic and its flexible member is manufactured from silicone is integral with said lid, the valve assembly and the medicine cup.

8. The dispensing device as claimed in claims 1 and 8, the soft removable Handles assembly consisting of the base, the upper opening, the handles designed for easy grip of the Medicup and the Strawcup and formed as one unit of flexible plastic covered by silicone or other flexible, suitable material.

9. The dispensing device, as claimed in claims 1 and 9, the leak-free dispensing openings with “x” or “x-wavy” slits are integral with the medicine dispensing duct and the conduit for liquid beverage of said valve assembly.

10. The dispensing device, as claimed in claims 1 and 10, the lids mouth/opening integral with the soft drinking spout and the soft drinking straw with attached flexible, plastic weighted straw.

11. The drinking devices; two soft removable drinking spouts and four dispensing valves, as shown and described.
The drinking devices, as darned in claim 11, each soft drinking spout formed with one of four leak-free valves with “x” or “x-wavy” dispensing slits molded in the apex's depression positioned and formed within spout's inner sidewalls. The said spout is sized and dimensioned to fit for tight engagement with said lid's mouth/opening's rims.
The invention a drinking device, as darned in claim 11, the second soft drinking spout formed with its bulged sidewalls on its upper apex/tip's area and rigid bump/ring incorporated inside of the distal end. The spout also sized and dimensioned to fit for tight engagement with said lid's mouth/opening rims.

12. The drinking devices; four dispensing valves, as shown, described and clamed in claims 11 and 12. a) One and two dispensing valves formed in the depression positioned within the soft spout's inner sidewalls made of silicone with rigid sidewalls and flat thinner layer inside of each valve. Each valve consisting of one or two valves connected to spout's inner sidewalls (one and two valves) and between each other (two valves). Each valve comprising “x” or “x-wavy” dispensing slits sized and dimensioned for adequately high liquid flow when infant, toddler or child is drinking liquid from the spout. b) Three and four leak-free dispensing valves formed in the depression positioned within the soft spout's inner sidewalls made of silicone with rigid sidewalls and flat thinner layer inside of each valve. Each valve connected to spout's inner sidewalls and between each other. The spouts apexes/openings comprise three or four valves with “x” or “x-wavy” dispensing slits sized and dimensioned for adequately high liquid flow when infant, toddler or child is drinking liquid from the spout.

13. The Strawcup with its all embodiments is interchangeable with the Medicup, as shown and described.
The Strawcup of the present invention, as claimed in claim 13 is a drinking device for infants, toddlers and children with interchangeable parts with the Medicup comprising:
a drinking cup for holding liquid beverage, said cup having a threaded neck portion at the upper end that defines an opening within;
a lid with hollow space inside, having threads in the interior distal portion of said lid that connects with the threads of said drinking cup;
a leak-free air vent with its hard and soft member located on said lid for ventilation into said cup;
two soft drinking straws with leak-free valves comprising “x” or “x-wavy” dispensing slits and extended soft distal ends for connection with flexible, plastic, weighted straws;
the plastic straw's distal end of each soft drinking straw comprising internal funnel-shape and weighted curved outer sidewalls which helps child to collect and drink all or most liquid from a drinking cup when it is connected to an upper soft drinking straw/mouthpiece;
a lid's mouth/opening constructed and sized in similar way as the Medicup's lid to fit for tight engagement with said soft drinking straw or the soft drinking spout;
each soft drinking straw is constructed and sized to fit for tight engagement with any of the two lid's mouth/opening's rims;
ornamental designs for said lid such as stars, ovals, happy face are made for decorative purpose;
three ornamental attachments for drinking cup and soft leaves are made for decorative purpose but the leaves also for easy gripping of the drinking cup;
soft removable Handles assembly designed for easy grip of the Strawcup and formed of flexible plastic covered by silicone or other flexible, suitable material;
a lid's cover made for the Strawcup fitting onto the top of its lid.

14. A drinking device as set forth in claims 13 and 14, further comprising: the screw-on lid is integral with said drinking cup and other preferred embodiments.

15. The drinking device, as claimed in claims 13, 14 and 15, the lid mouth/opening integral with the soft drinking straw and the soft drinking spout.

16. The drinking devices; two soft removable drinking straws with attached flexible, plastic slightly curved weighted straws, as shown and described.
The drinking devices, as claimed in claims 13 and 16, the two said soft drinking straws, each comprising the leak-free valve with rigid sidewalls and “x” or “x-wavy” slits. Each said soft drinking straw integral with slightly bended, flexible, plastic straw comprising internal funnel-shape distal end and weighted curved outer sidewalls for collecting and delivery of the liquid;
The drinking devices, two similar soft drinking straws/mouthpieces have only different shape of the drinking tips/apexes as claimed in claims 13 and 16.

17. The drinking device, as claimed in claims 13 and 17, the leak-free air vent with “x” or “x-wavy” shaped slits constructed and formed in similar way as the Medicup's air vents is integral with screw-on lid and consisting of two parts; the hard plastic made of decorative shape and its flexible member manufactured from silicone.

18. The ornamental designs for said cups and lids, as shown and described.
The ornamental designs, as claimed in claims 1 and 18, are the stars, the ovals, the happy face and the soft leaves. The said soft leaves made for gripping area of the hard cup formed of very soft, safe material.
The lid's decorative elements such as the stars, the ovals and the happy face made of soft material or printed. All said decorations are made for the drinking cups and the lids of both said drinking devices the Medicup and the Strawcup, as shown and described.

19. The ornamental designs for said cups, as shown and described.
The ornamental designs, as claimed in claims 1 and 19, three ornamental attachments designed for decorative purpose and made of combination of plastic and soft material for the drinking cup's bottom or printed. All said decorations are made for the drinking cups of both said drinking devices the Medicup and the Strawcup, as shown and described.

20. The lid's cover as shown, described and claimed in claims 1, 13 and 20, two similar lid covers are made, one for the Medicup and one for the Strawcup fitting onto the top of each lid.
